(19) United States
(12) Patent Application Publication
(10) Pub. No.: US 2011/0094040 A1
(43) Pub. Date: Apr. 28, 2011

(54) MULTI-COMPARTMENTED BODY SUPPORT SYSTEM WITH MULTI-PORT VALVE ASSEMBLY

(75) Inventors: Jules A. deGreef, Sandy, UT (US); David B. Beck, Draper, UT (US); Corey B. Welch, North Salt Lake City, UT (US)

(73) Assignee: R & D Products, LLC, Sandy, UT (US)

(21) Appl. No.: 12/604,901

(22) Filed: Oct. 23, 2009

(51) Int. Cl. A47C 27/10; G05D 7/06

(52) U.S. Cl. 5/713; 5/655.3; 700/282

(57) ABSTRACT

A system and method for controlling the flow of fluid for an inflatable body support 30 system, such as a mattress, having multiple, inflatable chambers. Each inflatable chamber can be selectively and independently inflated and deflated to vary the pressure exerted from the mattress surface to selected areas of a human body, thereby preventing the formation of decubitus ulcers. The system includes a valve assembly that includes a plurality of solenoid valves to direct air at a pressure of less than 1 pound per square inch into each chamber and a separate vent valve all operable by a controller to regulate the level of inflation of each inflatable chamber.

### BACKGROUND

1. Field

The present inventions relate to an inflatable structure for supporting at least a portion of a person's body. More specifically, the inflatable structure has multiple chambers some or all of which can be selectively inflated and/or deflated individually or simultaneously to increase and decrease the rigidity of different portions of the support surface in contact with different points or portions of the human body. Even more specifically, the present inventions relate to mattresses.

2. The Relevant Technology

There is a belief that pressure sores or bedsores develop when a bed-ridden person does not move for extended periods of time. That is, immobile people (e.g., unconscious, comatose, paralyzed, severely injured) typically do not move or are unable to move for extended periods of time (e.g., days, weeks). Immobile people who are bed ridden may remain essentially in the same location on the bed fostering the development of bedsores.

Bedsores are visually disfiguring, are generally regarded as painful, and are typically debilitating. In some cases, they are believed to lead to other maladies or medical complications, including various infections and infectious arthritis. Bedsores also are believed to lead to scar carcinoma, a form of cancer that develops in scar tissue. In short, bedsores pose a risk for bedridden people/patients in hospitals, nursing homes, and even at home when involved with a home health care treatment protocol.

It is presently understood that bedsores generally form at points of pressure, where the weight of the patient's body presses the skin against the firm surface of a bed or other support surface. The skin's blood supply is believed to be interrupted or reduced by the pressure, in turn, causing injury to skin cells. Unless the pressure is periodically relieved to allow full blood flow to the pressed areas of the skin, it is believed that ulcerations may more readily develop in the area. The ulcerations can grow into notable bedsores some in excess of the area of a quarter or half dollar.

Inflatable mattresses have been proposed for use by or with immobile people. Many in the past are believed to be difficult to operate, expensive, and unreliable. An inflatable mattress that varies the pressure in separate cells under different parts of the body and that accurately and promptly operates to maintain the pressure and then vary it in accordance with individual or preprogrammed instructions is disclosed in U.S. Pat. No. 7,219,380 B2 (Beck, et al.). The multi-compartmented mattress of Beck, et al., involves use of inflation structure that is large and bulky. It is also believed that it is not likely to be durable and may also need servicing and repair from time to time. There remains a need for a multi-compartmented body support system, such as a mattress, seat and/or chair that employs an improved fluid control assembly to the various compartments forming a body support system.

### SUMMARY

An inflatable body support system for supporting a body positioned thereon includes a plurality of inflatable chambers each having a flexible wall member having an interior surface and an exterior surface. While the chambers are shown as a parallelepiped, they may be formed in any suitable shape desired. Further, it should be understood, that the wall member may in fact include one or more rigid sides so long as one side is deflectable and the deflection is measurable. Alternately, the walls may contain or be an elastically deformable bladder that includes a pressure detector or has a flexible potentiometer on its surface to sense deflection.

As illustrated, the wall members are shaped to define an interior volume. Each of the plurality of inflatable chambers has a chamber connector for communicating fluid into and out of the interior volume. In operation, the flexible wall member is deflectable between a first inflated position and a second inflated position. The second inflated position is different from said first inflated position.

A plurality of flexible potentiometers each predictably vary their electrical resistance upon deflection from a first configuration to a second configuration when an electrical signal is applied thereto. Each of the plurality of flexible potentiometers is attached to the flexible wall member (or a bladder in another configuration) of one of the plurality of inflatable chambers to move from a first configuration to a second configuration when the related flexible wall member moves between its first inflated position and its second inflated position. Each of the plurality of flexible potentiometers is configured to supply or generate a deflection signal reflective of movement of the flexible wall member between its first inflated position and its second inflated position.

The system includes a fluid source for supplying a fluid under pressure to a first valve assembly connected to receive the fluid under pressure from the fluid source. The valve assembly is also connected to each chamber connector of each inflatable chamber for communication of fluid there between. The first valve assembly has a plurality of solenoid valves (preferably about 6) each configured to receive the fluid under pressure from the fluid source and each connected to supply the fluid under pressure to at least one of the plurality of inflatable chambers. Each of the solenoid valves of said first valve assembly is operable between a first valve position to allow fluid flow to and from at least one of the plurality of inflatable chambers and a second valve position inhibiting fluid flow to and from at least one of the plurality of inflatable chambers.

A plurality of first conduits are each connected to the valve assembly on one end thereof and each connected to a chamber connector of at least one of the plurality of inflatable chambers on the other end thereof. Each of the plurality of first conduits is configured for conveying fluid under pressure (e.g., air) between each of the said solenoid valves of the valve assembly and at least one of the plurality of inflatable chambers. That is, a solenoid valve may be connected to supply a plurality of inflatable chambers and even a particular group or pattern. A second conduit is connected to the fluid source and to the first valve assembly for conveying fluid from the fluid source to the first valve assembly.

A vent valve is positioned in the second conduit to receive fluid from the source and to the first valve assembly to supply fluid thereto. That is, the second conduit may be split or separated with each end connected to the vent value housing to transmit the fluid there through as discussed hereinafter. The vent valve has a vent to discharge fluid. The vent valve is operable between a first position connecting the fluid source to the first valve assembly and a second position connecting the first valve assembly to the vent.

The system also includes a controller connected to each of the plurality of flexible potentiometers for supplying an electrical signal thereto and for receiving the deflection signals there from. The controller processes the deflection signals and generates an open and closed signal through conductors connected to each of the plurality of solenoid valves and to the vent valve. That is, the controller is configured to generate operating signals for operating each of the solenoid valves of the first valve assembly between their first position and their second position. The controller also generates operating signals to cause the vent valve to move between its first position and its second position.

In an alternate arrangement, the body support system also has a second valve assembly in fluid communication with said the first valve assembly to transmit fluid under pressure there between. The second valve assembly includes a plurality of solenoid valves each connected to be controllable by the controller the same as the solenoid valves of the first valve assembly. Each solenoid valve of the second valve assembly is connected to at least one of the plurality of inflatable chambers. Each of the solenoid valves of the second valve assembly is operable between a first valve position to allow fluid flow to and from at least one of the plurality of inflatable chambers and a second valve position inhibiting fluid flow to and from the a plurality of inflatable chambers.

In a more preferred configuration, the fluid source is a pump and the fluid is air. In another configuration, the first valve assembly has a first plenum connected to a first vent valve. The first valve assembly has a plurality of discharge ports for connection with each of the plurality of first conduits. When the vent valve is aligned to the vent position, fluid is transmitted from the inflated chamber through the second conduit and the discharge port, through the valve and into the plenum for transmission through the first conduit and the vent valve. The vent valve is positioned to transmit fluid to the vent. Thus, the pressure of the fluid in the inflatable chamber can be lowered if excessive.

In a alternate and more preferred configuration, the first valve assembly has six solenoid valves. With the vent valve in the position in which air proceeds from the pump to the valve assembly, air pump supplies said fluid under pressure at a low pressure of about up to 5 pounds per square inch and most preferably at a very low pressure of under 1 pound per square inch and operationally at about 0.5 pounds per square inch.

Various other alternate and preferred embodiments of the present invention are set forth and described hereinafter. Some are illustrated in the attached figures and in the detailed description of the invention as provided herein and as embodied by the claims. It should be understood, however, that this summary does not contain all of the aspects and embodiments of the present invention. This summary is not meant to be limiting or restrictive in any manner; and the inventions as disclosed herein will be understood by those of ordinary skill in the art to encompass obvious improvements and modifications thereto.

### BRIEF DESCRIPTION OF THE DRAWINGS

To further clarify the above and other advantages and features of the one or more present inventions, a more particular description is provided by reference to specific embodiments that are illustrated in the appended drawings. It is appreciated that these drawings depict only typical embodiments of the invention and are therefore not to be considered limiting of its scope. Embodiments will be described and explained with additional specificity and detail through the use of the accompanying drawings in which:

FIG. 1 illustrates an embodiment of an inflatable mattress system of the present inventions;

FIG. 2 illustrates an exploded perspective view of an inflatable mattress for use in a system of the present invention;

FIG. 3 illustrates an inflatable mattress system using several different sized inflatable chambers for use in the system of the present invention;

FIG. 4 illustrates a side view of an individual inflatable chamber in the system of the present invention;

FIG. 5 illustrates a bottom view of an individual inflatable chamber of FIG. 4;

FIG. 6 illustrates a top view of an individual inflatable chamber of FIG. 4;

FIG. 7 is a block diagram depicting an inflatable system of the present invention;

FIG. 8A illustrates a perspective view of a valve assembly for use with an inflatable system of the present invention;

FIG. 8B is an end elevation view of the valve assembly shown in FIG. 8A;

FIG. 8C is a side elevation view of valve assembly shown in FIG. 8A;

FIG. 8D is another end elevation view of the valve assembly shown in FIG. 8A;

FIG. 8E is a top plan view of the valve assembly shown in FIG. 8A;

FIG. 9 is a perspective exploded view of a valve assembly for use with an inflatable system of the present invention;

FIG. 10 is a simplified block diagram illustrating an inflatable system of the present invention;

FIG. 11 is a simplified block diagram illustrating an inflatable system of the present invention;

FIG. 12 is a simplified plan view depicting an alternate arrangement of an inflatable mattress for use with an inflatable system of the present invention;

FIG. 13 is a perspective view of interconnected valve assemblies for use with the inflatable system of the present invention;

FIG. 14 is a simplified cross sectional cut-away depiction of a solenoid valve for use in the system depicted in FIGS. 8A-E and 9;

FIG. 15 is a simplified enlarged view of the top of the valve assembly of FIG. 8A;

FIG. 16 is a simplified enlarged view of the upper portion of the housing of the valve assembly of FIG. 8A with the top of FIG. 15 removed;

FIG. 17 is a partial perspective view of a portion of the housing of the valve assembly of FIG. 8A;

FIG. 18 is a partial perspective view of a portion of the housing of the valve assembly of FIG. 8A;

FIG. 19 is a partial side view of the top of the housing and a related gasket for use with the valve assembly of FIG. 8A;

FIG. 20 is a simplified top plan view of a vent valve for use in the system of the present invention;

FIG. 21 is a side plan view of the vent valve of FIG. 20;

FIG. 22 is an alternate cross sectional side view of a valve assembly for use in the system of the present invention;

FIG. 23 is cross sectional perspective view of the valve assembly of FIG. 22 taken at section lines 23-23;

FIG. 24 is a simplified partial cross sectional enlarged view of portions of another alternate valve assembly for use in the present invention;

FIG. 25 is a perspective view of an alternate vent valve for use with a mattress system of FIG. 1;

FIG. 26 is a cross sectional depiction in perspective of a vent valve of FIG. 25 along section lines 26-26; and

FIG. 27 is a cross sectional depiction in perspective of a vent valve of FIG. 25 along section lines 27-27.

### DETAILED DESCRIPTION

Reference will now be made to one or more embodiments of the one or more present inventions, examples of which are illustrated in the accompanying drawings. The various exemplary embodiments provide a body support system, such as an inflatable mattress, having multiple, fluidly isolated inflatable chambers that can be selectively inflated and deflated to increase and decrease the pressure exerted from various points of the support surface on a human body.

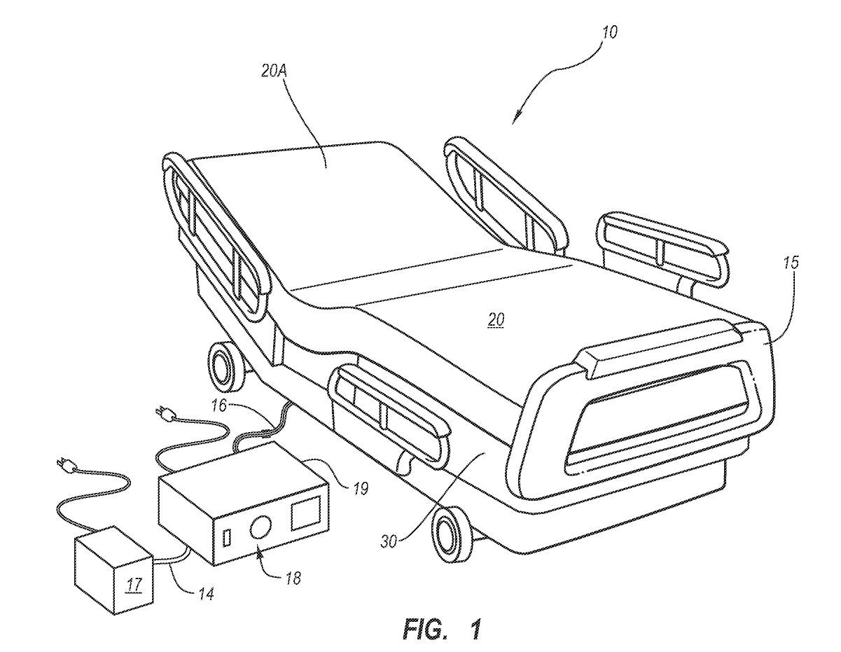

Referring now to FIG. 1, one embodiment of the present invention is for with or as part of a mattress system as part of a hospital bed 10. The hospital bed 10 includes a conventional hospital bed frame 15 and an inflatable mattress system that includes an inflatable mattress 20 with a support 30. The inflatable mattress 20 has a plurality of inflatable compartments or chambers configured to be supplied with an pressurized fluid from a controller 19 having suitable controls and indicators 18. The system also includes a pumping system 17 configured to supply a fluid (like air or some other suitable gas) under pressure (e.g., 0.5 pounds per square inch) to the controller 19 via tube 14 and then to the various compartments or chambers of the inflatable mattress 20 through tubes 16 as discussed hereinafter.

The inflatable mattress system that includes the mattress, 20 and related components like the controller 19, pumping system 17 and related tube 14 and tubes 16 may also be reconfigured to be used in other applications. That is, a support surface to support a person, in lieu of being configured as a mattress, may be configured for use in other body support devices, such as chairs and seats.

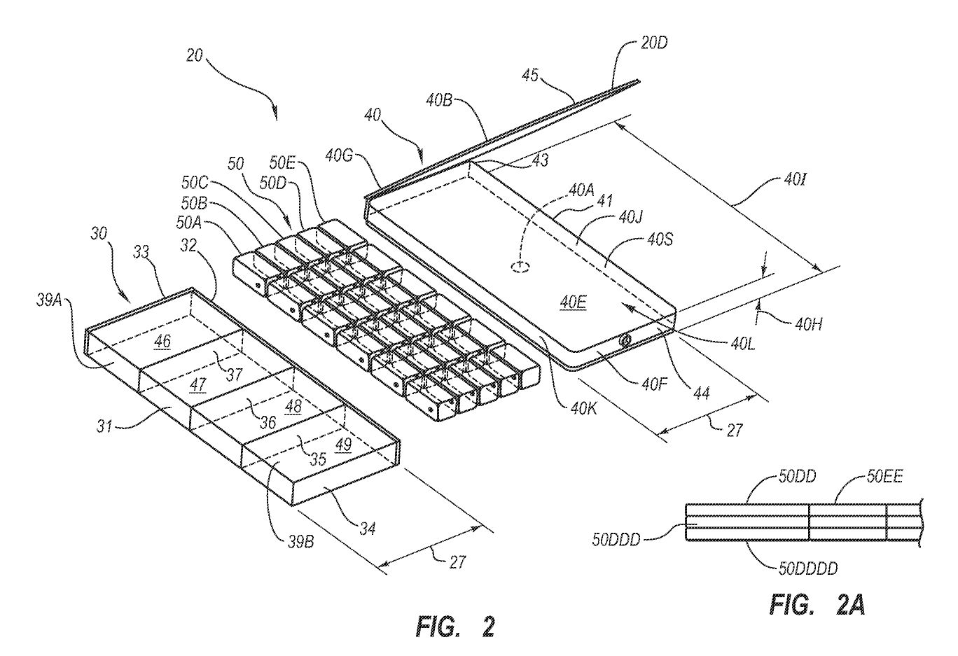

Referring now to FIG. 2, the inflatable mattress 20 has a chamber portion 50 that fits into and is positioned within a housing portion 40. FIG. 2 also illustrates a bottom or support 30 that functions much like an inner spring of a typical coil or leaf spring mattress now made for home use.

Chamber portion 50 seen in FIG. 2 is a matrix of inflatable chambers such as representative chambers 50A-E. The size and shape of selected chambers may vary based on different factors such as the intended or expected use, the size of the person one expects to be supported, the nature of the involved impairment making the person immobile, the location and similar factors.

As constructed, the chamber portion 50 is a parallelepiped. Similarly, the housing portion 40 is a parallelepiped. However, it should be understood that the housing portion 40 and/or the chamber portion 50 as well as the bottom or support 30 may be formed in virtually any geometric shape one would want (e.g., circular, oval, heart shaped). Further, the housing portion 40 may have portions that are made comparable to a conventional mattress to provide a space 40L configured to receive the chamber portion 50 in whatever shape is desired such as a parallelepiped.

Typically, the chamber portion 50 and the housing portion 40 are shaped as parallelepipeds. Thus, the chamber portion 50 is generally rectangular in projection and sized in height 40H, in length 40I and in width 27 to snuggly fit on or in a suitable housing portion 40 and for positioning on the support 30 which is further support on the conventional hospital bed frame 15. The inflatable mattress 20 may be sized to fit into or on other conventional bed frames. Single, double, queen size and king size versions are contemplated. The inflatable mattress 20 for larger versions may have two supports 30. Also, the housing portion 40 may be sized to accommodate two separate chamber portions 50 in a side by side relationship.

The container or housing portion 40 of the inflatable mattress 20 of FIGS. 1 and 2 has an upper surface 40B that may be, and in this embodiment is, the same as the surface 20A of the mattress 20. The housing portion 40 also has a bottom surface 40E and sides 40F, 40G, 40J and 40K configured and assembled as shown to define a space 40L sized to receive and preferably snuggly receive the chamber portion 50. The bottom surface 40E and sides 40F, 40G, 40J and 40K are each made of a material that is selected to be flexible and have suitable wearing characteristics to resist punctures. The material is cleanable and relatively strong. While woven materials may be used in some application, a wide variety of synthetic products including plastic (e.g., polypropylene) or plastic-like materials are preferred to fabricate the housing portion 40. In some cases, the upper surface 40B may have padding for comfort and insulation.

In FIG. 2, the housing portion 40 is shown having a lid 45 which is discussed more fully below. The bottom surface 40E and the sides 40F and 40G may be made of a thicker or more durable material in relation to the upper surface so the inflatable mattress 20 is able to maintain a reasonable degree of rigidity when the chamber portion 50 is inflated. However, in preferred arrangements, the upper surface 40D and bottom surface 40E as well as the sides 40F, 40G, 40K and 40J may be made of the same material.

As seen in FIG. 2, the bottom or support 30 depicted is a generally rectangular structure having opposite side walls 31 and 32 and opposite ends 33 and 34. The bottom or support 30 is here shown to have four separate compartments 46, 47, 48 and 49 separated by compartment dividers 35, 36 and 37. The compartment dividers 35, 36 and 37 extend between the lower surface 39A and the upper surface 39B to provide structural support to the side walls 31 and 32 as well as support for the upper surface 39B (shown in cut-away). The bottom or support 30 functions to support the housing portion 40 with the chamber portion 50 in the base and a user positioned thereon. The upper surface 39B and preferably the lower surface 39A extends between the side walls 31 and 32 and the ends 33 and 34. The number of compartments 46-49 in the bottom or support 30 may vary from 1 to as many as one may practically desire. The compartments 46-49 may be filled with any suitable material to provide the rigid support desired. Latex, coil springs, leaf springs, spring lattice structures and even liquid or air in suitable chambers may be used to provide the desired rigidity and support in the compartments 46-49.

As shown in FIG. 2, the lid 45 preferably functions as the upper surface 40B. The lid 45 is then configured to be securely fastened to the sides 40F, 40G, 40J and 40K and more specifically to the edge 41 of the side walls, 40F, 40G, 40J and 40K by any suitable means such as a zipper. For example, the adjoining edges may be formed with a zipper like arrangement. If one edge, such as, for example, edge 41 remains zipped, that edge then functions much like a hinge so the cover or lid 45 may be hingedly opened to provide access to the chamber portion 50. Of course, the lid 45 is not rigid as shown as it is formed from a flexible plastic like material. The interior has a suitable aperture like aperture 40A to allow tubes from each chamber such as chambers 50A-E to be assembled into a bundle of tubes 16 to pass through aperture 40A in the bottom surface 40E for further connection to the chassis of the controller 19 for supplying and removing fluid (e.g., air) for the purpose of inflation and deflation.

In other configurations, the lid 45 may be made from a fabric such as lycra®. If the sides 40S, 40F, 40K, 40G of housing portion 40 are formed with a rib along an edge such as edge 41, conventional sewing stitches may be used to secure removable lid 45 to the rib at the edge 41. Removable lid 45 is then secured to the side walls or edge 41 with suitable fasteners that can include buttons, snaps, interactive hook and pile fasteners (e.g., Velcro® fasteners) as well as other forms of zippers. Virtually, any suitable mechanism or means to associate the lid 45 to the cavity of the housing portion 40 may be used to effect a mechanical association.

While the chamber portion 50 shown in FIG. 2 are formed to be in a shape comparable to a brick, they may be in any suitable configuration or shape desired. For example, the chambers maybe cube-like or even cylindrical in shape. Optional solid (e.g., neoprene) material may be used to construct the chambers 50A-E and organize them in any suitable or desired pattern. As shown in FIG. 2A, the chambers 50 in one or more or all of the sections may be formed in a thin wafer like form. That is, in an alternate and not preferred arrangement, one or more chambers like chambers 50D and 50E may be formed to be thin with one or more of the chambers 50DD, 50DDD and 50DDDD inflatable and the others filled with something that is not inflatable or a material that is resilient. In other words, the chambers may be assembled in a variety of configurations to meet any desired level of support rigidity or firmness.

In the illustrated embodiment, the mattress system of FIG. 1 is sized or depicted as an approximate single or twin mattress for use in a typical hospital bed. However, any mattress size (e.g. king, queen, full or other) may be manufactured using the inflatable multi-cell design described herein without departing from the intended scope and spirit of the invention. Further, other support surfaces such as those used to support the body on a gurney, on an operating table, and the like may employ the principles herein discussed and illustrated to provide a support surface to reduce discomfort and/or minimize the risk of induced medical problems.

In use, it is possible that one or more inflatable chambers 50A-E of the chamber portion 50 may be damaged and start to leak. In that event, it is desirable that coverings be removable, such as lid 45, so that one may access a chamber and be able to effect repairs (e.g., affix a suitable patch). Thus, any of the plurality of inflatable chambers 50A-E within inflatable mattress 20 may be easily replaced if and when formed to be separate from each other (no common wall) or repaired.

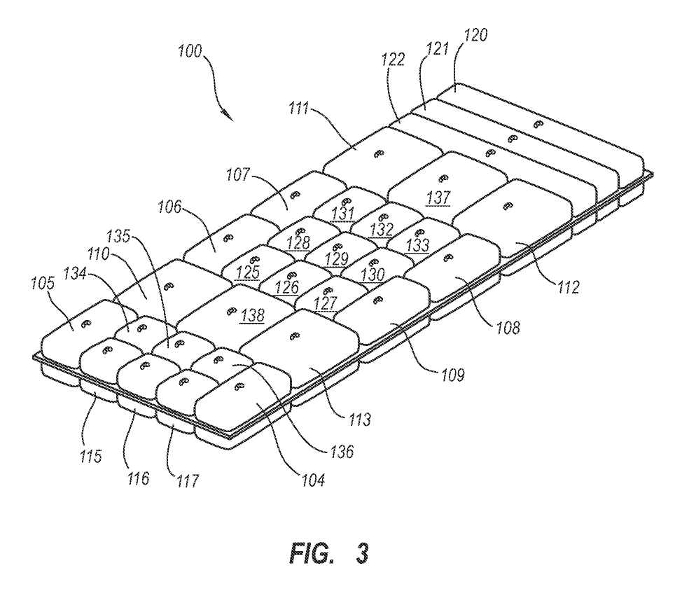

Referring now to FIG. 3, one embodiment of inflatable mattress system 100 having multiple cells or inflatable chambers of differing sizes arranged in an advantageous manner to minimize the occurrence of bedsores in a patient is illustrated. In the illustrated embodiment, a group of elongated inflatable chambers 120, 121 and 122 are positioned where an individual's head would typically rest on the mattress surface. The elongated inflatable chambers 120, 121 and 122 are sized to provide maximum comfort to an individual's head and neck area. A group of large inflatable chambers 110, 111, 112, 113, 137 and 138 are located where an individual's shoulders and legs would typically be located on the mattress. The large inflatable chambers 110, 111, 112, 113, 137 and 138 are sized to provide a comfortable cushioned surface for large areas of the human body not susceptible to the formation of bedsores.

In a preferred construction, a group of small inflatable chambers 115, 116, 117, 134, 135 and 136 are positioned where an individual's feet will reside and a group of small inflatable chambers 125, 126, 127, 128, 129, 130, 131, 132 and 133 are positioned where an individual's back and gluteus maximus would typically be located. Selective inflation and deflation of the illustrated small inflatable chambers 125, 126, 127, 128, 129, 130, 131, 132 and 133 provides a variation of the pressure at points of contact between the mattress surface and the body at the most common places for the development of bedsores on a bed-ridden individual. Since the inflatable chambers are small, alternating the amount of pressure from even 1.0 to 1.1 psi can significantly vary the softness or hardness to the touch. In turn, pressure points supporting the weight of a person on the mattress may be changed between the hips and feet and back of an individual. A group of medium sized inflatable chambers 104, 105, 106, 107, 108 and 109 are located adjacent the group of small inflatable chambers. The medium sized inflatable chambers 104, 105, 106, 107, 108 and 109 provide a measure of support for a grouping of small sized inflatable chambers. 125-133, 115-117 and 134-136. The medium sized inflatable chambers 104, 105, 106, 107, 108 and 109 may also be selectively inflated and deflated to vary the support under the arms and also to assist when moving or rolling a person over or onto a side.

In a preferred embodiment, the inflatable chambers are sized and placed according to the average weight and size of a typical human body. In other embodiments, inflatable chambers may be larger sized to accommodate the weight of a very large person or smaller sized to accommodate the weight of a baby or child. Preferably, elongated inflatable chambers 120, 121 and 122 are sized in a range of approximately 36.0 inches by 3.7 inches to 37 inches by 4.7 inches, and are preferably 36.5 inches by 4.2 inches. Large inflatable chambers 110, 111, 112 and 113 are sized in a range of approximately 13.0 inches by 11.3 inches to 14.0 inches by 12.3 inches, and are preferably 12.5 inches by 10.8 inches. Small inflatable chambers 115, 116 and 117 are sized in a range of approximately 8.3 inches by 6.4 inches to 9.3 inches by 7.4 inches, and are preferably 8.8 inches by 6.9 inches. Medium sized inflatable chambers 104, 105, 106, 107, 108 and 109 are sized in a range of approximately 13.0 inches by 6.4 inches to 14.0 inches by 7.4 inches, and are preferably 12.5 inches by 6.9 inches. Preferably, elongated inflatable chambers, large inflatable chambers, small inflatable chambers and medium inflatable chambers are approximately 3.0 inches thick.

The inflatable chambers illustrated in FIG. 3 are not directly fluidly connected, so each inflatable chamber may be individually inflated and deflated. Such an arrangement also allows for easy removal and replacement of any worn or damaged cells if the cells are each configured to be complete and not share common walls with adjacent cells. However, it is within contemplation that two or more chambers like medium sized inflatable chamber 106 and 107 may be fluidly interconnected and operated by one fluid supply line.

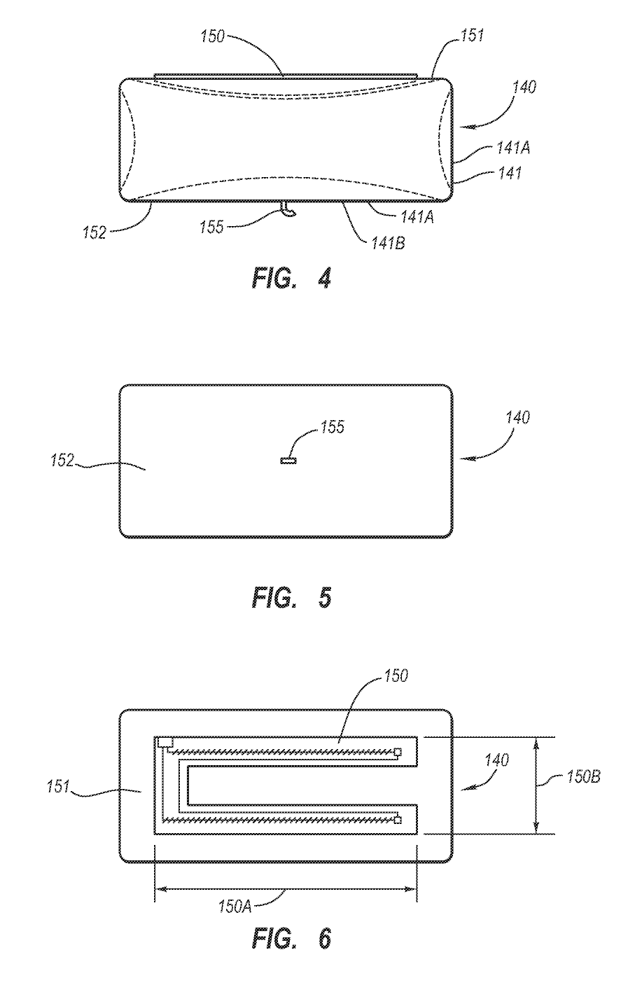

FIGS. 4, 5 and 6 illustrate, respectively, a side view, a bottom view and a top view of inflatable chamber 140 that is part of the inflatable mattress 20. Inflatable chamber 140 is constructed of any substantially non-porous, flexible material that forms a wall 141 having an exterior surface 141A and an interior surface 141C. For example, inflatable chamber 140 may be manufactured of a vinyl material, the thickness of the material falling within a range from about 0.015 inches to about 0.04 inches, and preferably, is 0.02 inches. Any similar material may be used. A suitable material should be weldable and sealable to create an interior volume in the interior of the inflatable chamber 140, such that a fluid may be introduced to inflate the cell and to retain the fluid without leaking. In one preferred embodiment, one surface of the inflatable chamber is constructed of a non-porous, flexible material. It is within contemplation that two, up to all the surfaces of a parallelepiped may be constructed from the non-porous flexible material.

The top surface 151 (see FIG. 6) is relatively smooth and adapted to support at least a portion of the weight of an individual positioned on the surface of the inflatable mattress 20. The bottom surface 152 has a chamber connector 155 that either introduces fluid into or releases fluid from the interior of the inflatable chamber 140. Chamber connector 155 may be positioned on any surface of inflatable chamber 140 but is preferably positioned in the bottom surface 152 so that connecting conduits may not interfere with the construction of the inflatable mattress 20 and not interfere with the user on the hospital bed 10. Thus, the chamber connector 155 is configured to connect to a fluid conduit 160, such as piping, tubing, and hoses, to be part of tube bundle 16 (FIG. 1) for communicating fluid to and from the interior volume. In the illustrated embodiment, chamber connector 155 is a fitting that self seals but can form an aperture in inflatable chamber 140 upon introduction of the fluid conduit 160. However, chamber connector 155 may be any element suitable for fluidly communicating between the interior volume of inflatable chamber 140 and any element that supplies, releases or measures fluid such as, for example, a valve, a connector, a PVC or metal conduit, a female or male adapter or a liquid tight flexible conduit and fitting.

In FIG. 6, a flexible potentiometer 150 is shown. It is selected to have a suitable length 150A and width 150B and is secured to a surface of inflatable chamber 140 to detect the presence or absence of a deflection of that surface for any reason. Typically, the deflection of the inflatable chamber 140 from a first position 141A to a second position 141B (in FIG. 4) results from a portion of the weight of a person being positioned on the surface of the inflatable mattress 20 and more specifically, on a particular inflatable chamber like inflatable chamber 140. Of course, the deflection to second position 141B could also be the result of a leak, a change in temperature and/or the weight of any object or thing being placed on the surface of the inflatable mattress 20.

In a preferred embodiment, flexible potentiometer 150 is secured to the top surface 151 of inflatable chamber 140 and preferably to the top surface of all the flexible chambers (see FIG. 2) of the inflatable mattress 20. Flexible potentiometer 150 for the inflatable chamber 140 of FIG. 6 consists of a substrate that is an insulator (e.g., Kapton sold by E.I. duPont de Neumors & Co.) upon which a conductive ink with epoxy mixture is deposited in a way so that the ink deflects when the substrate is deflected as the inflatable chamber 140 goes from first position 141A to second position 141B. As the ink bends or deflects, its electrical conductivity changes. As the top surface 151 moves from a first position 141A to a second position 141B results, the conductive ink of the flexible potentiometer predictably changes its electrical conductivity. A suitable flexible potentiometer 150 is commercially available from Flexpoint Sensor Systems, 106 West 12200 South, West Jordan, Utah 84020. By applying an electrical signal such as a voltage or a current to the flexible potentiometer 150, a corresponding change in the current or voltage can be detected as the inflatable chamber 140 moves between first position 141B and second position 141C and, in turn, a signal reflective of deflection is determined and supplied to the controller 19 to inflate if low and deflate if high. Other devices (detection means) may be used in lieu of the flexible potentiometer. Pressure sensing and movement detecting devices may be adapted to detect a change in pressure and/or movement of the wall surface in applications contemplated.

A suitable flexible potentiometer for purposes of detecting a pressure point on the surface of inflatable chamber 140 is a Bend Sensor® potentiometer manufactured by Flexpoint Sensor System, Inc., also described in U.S. Pat. Nos. 5,157,372 and 5,583,476, the disclosure of which is hereby incorporated by reference for all purposes. Flexible potentiometer 150 is affixed to the surface of inflatable chamber 140 by any suitable means, and preferably is affixed by a pressure sensitive adhesive that adheres to the top surface of 151 without affecting the integrity of the material used to manufacture flexible potentiometer 150. In some cases, the ink of the flexible potentiometer may be silk screened directly onto an insulative surface of a inflatable chamber 140.

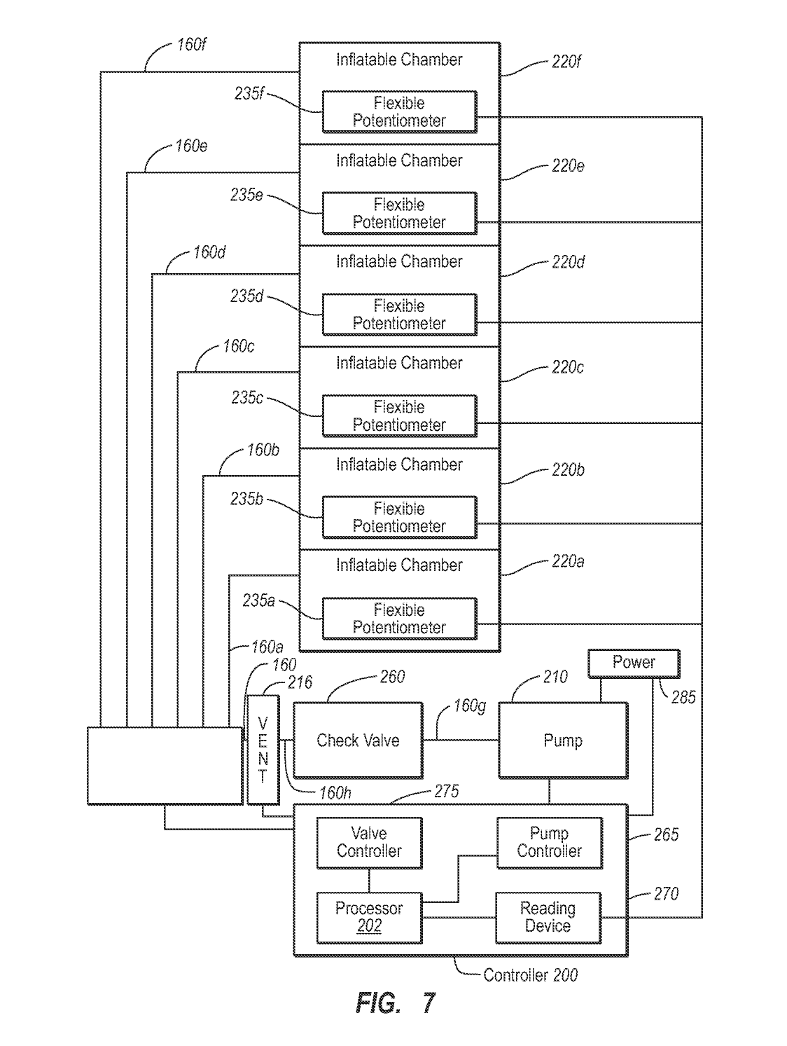

Referring now to FIG. 7, and in accordance with at least one embodiment of the one or more present inventions described herein, a block diagram illustrates the electrical and mechanical elements for controlling the operation of an inflatable support system, such as a inflatable mattress 20. In the illustrated embodiment, a controller 200 is communicatively coupled to a processor 202 having computer instructions embodied therein, the combination controlling the overall operation of the inflatable mattress system. Controller 200 is communicatively coupled to a fluid source or pump 210, a valve assembly 215, a vent valve 216 and a plurality of flexible potentiometers 235a-f. By appropriate operation of the controller 200, the pump 210 supplies a fluid such as air to and through vent valve 216 and a check valve 260 to the valve assembly 215. While fluid is here supplied by a pump 210, it should be understood that any suitable source of fluid under pressure (i.e., fluid supply means) like a pressurized bottle may be used in lieu of a pump.

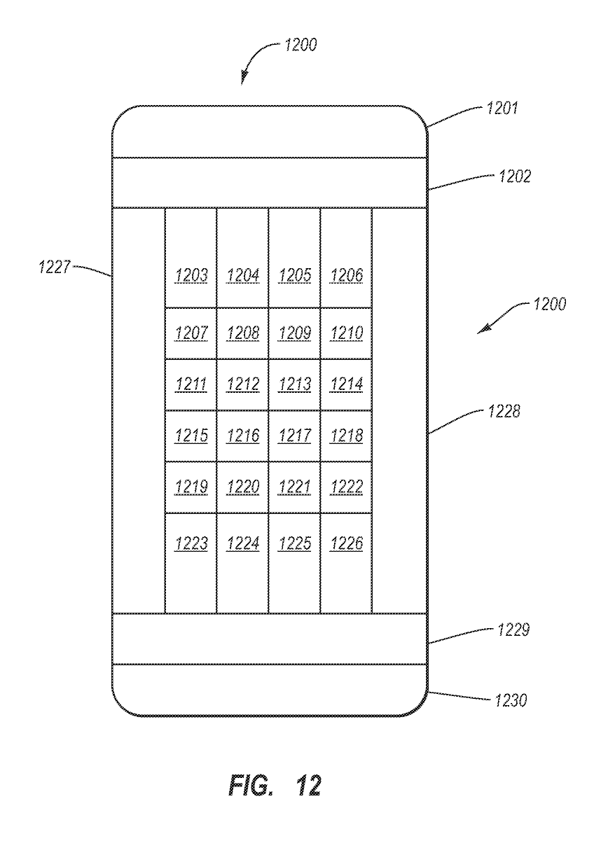

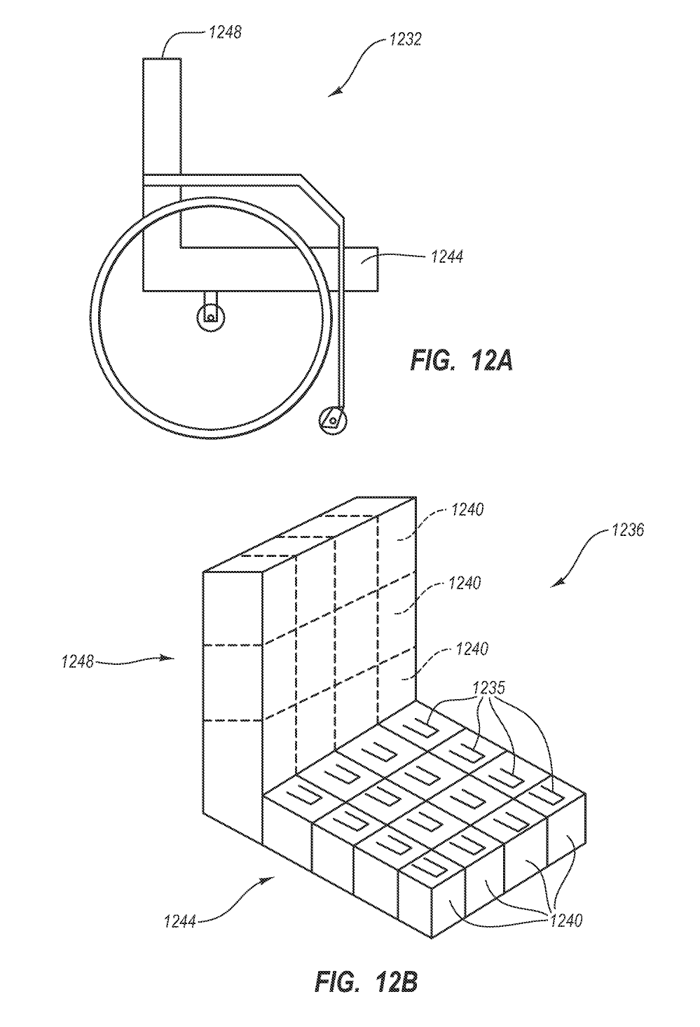

The valve assembly 215 is operated by the controller 200 for the introduction of a fluid such as air, within selected inflatable chambers 220a-f upon a deflection signal received from the flexible potentiometers 235a-f. Although six inflatable chambers are shown in FIG. 7, namely, inflatable chambers 220a, 220b, 220c, 220d, 220e and 220f, any number of inflatable chambers may be used depending upon the particular needs of a particular inflatable mattress system. For example, standard inflatable mattress systems in accordance with at least one embodiment may have a set number of inflatable chambers and configurations, while customized inflatable mattress systems may have an alternative number and/or size of inflatable chambers. Factors influencing the number of inflatable chambers and/or configuration used in a given inflatable mattress may include cost, as well as any one or more of the age, size, health, physical and/or mental attributes of a person to be supported by the associated mattress system. By way of example, an inflatable mattress system may comprise thirty inflatable chambers, such as the thirty inflatable chambers illustrated in FIGS. 3 and 12.

With further reference to FIG. 7 and the exemplary system depicted, controller 200 includes a portion that acts as a valve controller 275, a fluid source or pump controller 265 and a reading device 270. In alternate embodiments, controller 200 may be a mechanical or electrical device that incorporates the functions and operations of valve controller 275, pump controller 265 and reading device 270 in either a single device or multiple devices.

The valve controller 275 of the controller controls the operation of valve assembly 215 by sending a series of signals to the valve assembly 215 to perform various mechanical operations, such as selecting one or more inflatable chambers 220a-f for inflation or deflation. By way of example and not limitation, inflatable chambers 220a may be inflated and later deflated by aligning the valve assembly 215 and first supplying fluid through the check valve 260 via the vent valve 216 to the inflatable chambers 235a-f. If for some reason one or more chambers becomes over pressurized, the fluid can be vented by operating one or more of the valves in the valve assembly 215 and the vent valve 216. Pump controller 265 controls the duration of the flow of fluid, such as air, from fluid source or pump 210 to any one or more of inflatable chambers 220a-f by providing a signal to pump 210 to introduce pressurized fluid to the valve assembly 215. The fluid source or pump 210 may include a mechanical pump as well as a reservoir, such as a tank, that contains pressurized fluid, such as pressurized air. Reading device 270 receives a deflection signal from flexible potentiometers 235a-f to determine the location and amount of deflection of each of the inflatable chambers 220a-f, respectively. The controller 200 then directs the valves within the valve assembly 215 to remain unchanged, or to move to the appropriate position to either allow pressurized flow to its associated inflatable chamber 220a-f, or to allow the valve's associated inflatable chamber 200a-f to deflate through the vent valve 216.

In a preferred embodiment, controller 200 is embodied in any suitable programmable integrated circuit such as M30262 manufactured by Renesas. However, any suitable programmable integrated circuit may be used to supply operating commands that control the operation of valve assembly 215 and pump 210, as well as receive deflection measurements from flexible potentiometers 235a-f located at a surface of inflatable chambers 220a-f. For example, controller 200 may be embodied in an ASIC, or similar application specific integrated circuit.

Processor 205 preferably comprises any computer processor capable of executing a series of instructions to access data. It interfaces with the valve controller 275, pump controller 265 and the Reading device 270 to issue suitable commands and to receive feedback as appropriate. For example, processor 202 may contain instructions for selecting certain inflatable chambers 220a-f for inflation or deflation based on deflection information received from flexible potentiometers 235a-f. Processor 202 may also contain instructions for randomly selecting inflatable chambers 220a-f for inflation and deflation in a particular pattern that provides varying pressure points on the skin of an individual's body, thereby preventing the formation of bedsores.

In the illustrated embodiment, fluid source or pump 210 is coupled to valve assembly 215 through a check valve 260. However, pump 210 may be coupled directly to valve assembly 215 using a conduit, or pump 210 may be coupled to the valve assembly 215 through any number of intervening devices such as a flow meter. Check valve 260 preferably has a crack pressure of 0.15 psi, which prevents back flow through to the pump 210. By way of example and not limitation, pump 210 is preferably sized to provide at least 0.5 pound per square inch of pressure in inflatable chambers 220a-f. A suitable commercial model is a 110 VAC model # DDL15B-101, 23 L/m linear diaphragm pump manufactured by Gast that outputs approximately 5 pounds per square inch of pressure. However, any suitable fluid source or pump may be used that is sized in accordance with the particular requirements of the inflatable support system.

One or more power sources 285 are used to provide power to the pump 210, controller 200, and any other elements in FIG. 7 requiring power. The power source may be AC or DC with appropriate conversion devices, as required. Lines showing the deliver of power to other components have not been shown for simplicity.

Valve assembly 215 is fluidly connected to inflatable chambers 220a-f (FIG. 7) via fluid conduits 160a-f. Valve assembly 215 receives instructions from the controller 200 for controlling fluid flow to one or more of the inflatable chambers 220a-f for inflation or deflation, or to remain unchanged. Valve assembly 215 is operated to introduce fluid, such as pressurized air, from the fluid source or pump 210 via fluid conduit 160g, check valve 260, vent valve 216 and conduits 160h and 160i and through the valve assembly 215 and one or more applicable conduits 160a-f into one or more selected inflatable chambers 220a-f. To deflate, the valve assembly 215 remains aligned to one of the chambers 220a-f through the applicable conduit 160a-f. The pump 210 is turned off by the controller 200 while the vent valve 216 is actuated by the controller 200 to vent the fluid from the desired or selected chamber 220a-f. That is, the fluid comes from one or more of the desired or selected chambers 220a-f through the applicable conduits 160a-f and through the valve assembly 215 and through the valve 216 to a suitable reservoir or to the atmosphere. For one of the chambers 220a-f to remain inflated at a desired pressure, the vent valve 216 is closed and the valve assembly 215 closed to isolate the chambers 220a-f. Of course, the flexible potentiometers 235a-f actually sense deflection of the surface upon which they are mounted and not pressured because deflection is related to the pressure in the respective chambers 220a-f. The controller 200 supplies a current or voltage to each of the flexible potentiometers 235a-f via conductors which current or voltage predictably varies with deflection; and, in turn, the controller 200 converts that deflection signals into signals to cause the pump 210, valve assembly 215 and vent valve 216 to operate.

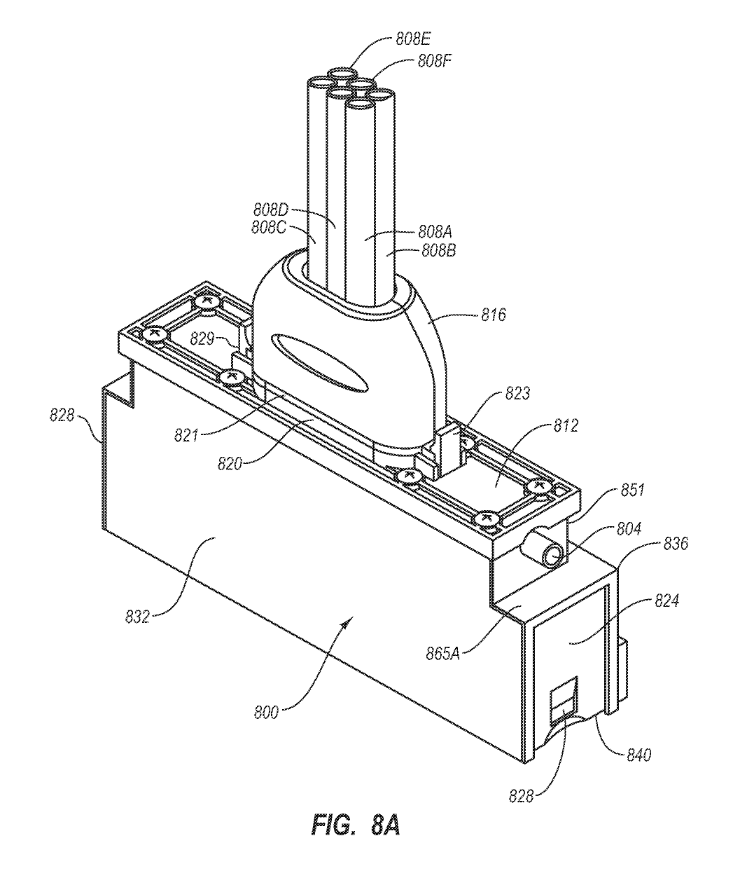

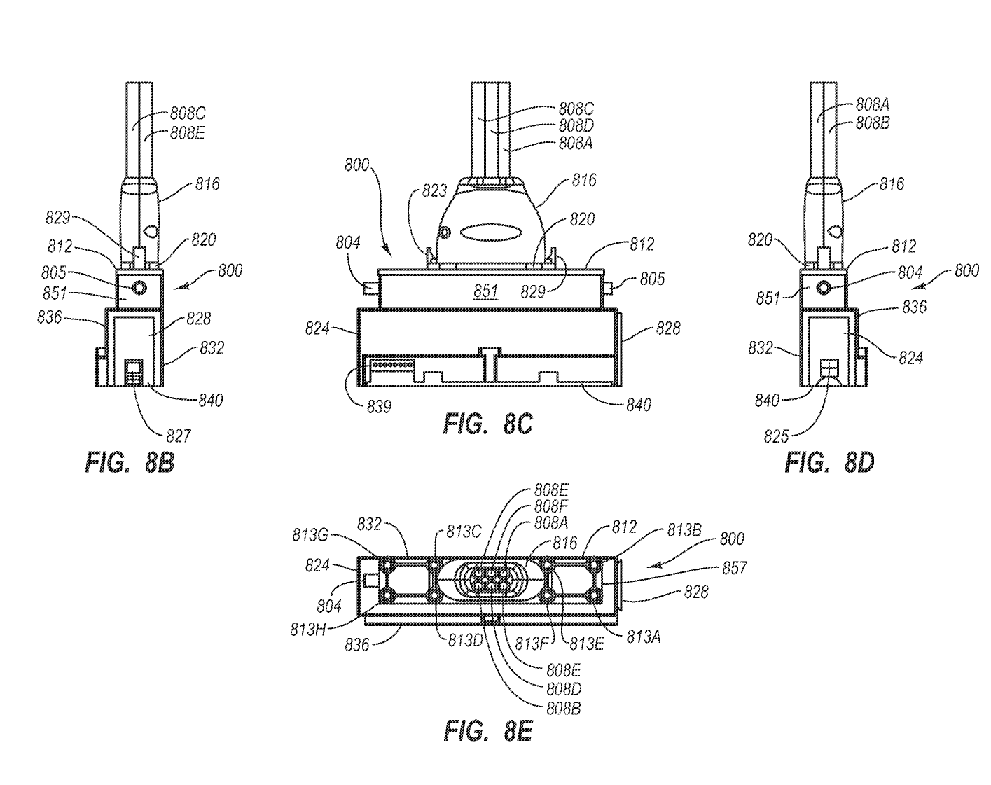

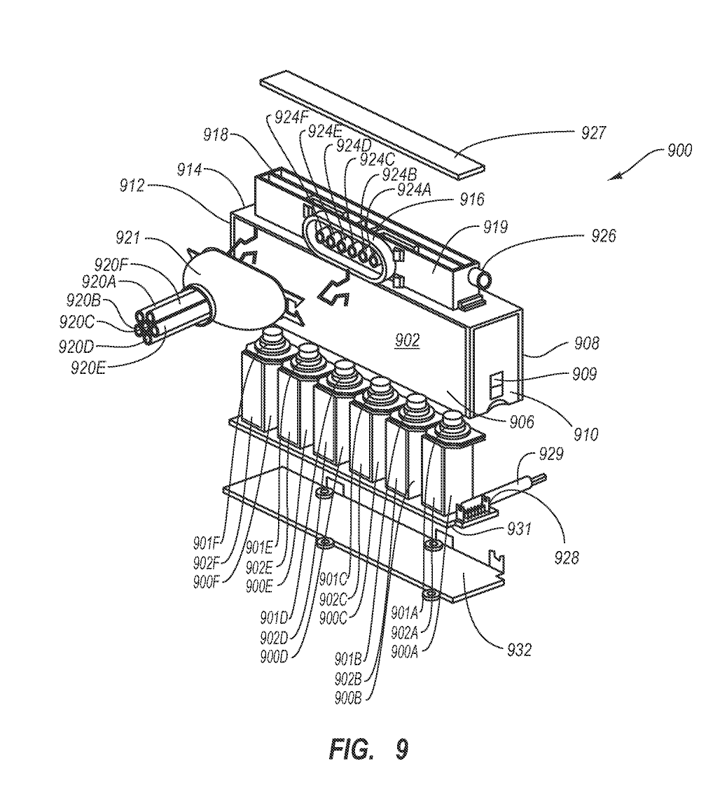

With reference now to FIGS. 8A-E, one embodiment of a valve assembly 215 having multiple ports comprises a plurality of separately controllable solenoid valves comparable to the solenoid valves having actuators 900A-F shown in FIG. 9. The valve assembly 215 of FIGS. 8A-E includes a housing 800 within which a number of two-port solenoid valves are located. The housing 800 includes a fluid port 804 to intake fluid and an alternate port 805 that is shown capped off. That is, fluid is supplied to the housing 800 through the intake port 804.

The valve assembly 215 is also connected to a plurality of fluid tubes 808A-F that function comparable to fluid conduits 160a-f to supply the fluid to the inflatable chambers like chambers 220a-f. As shown in FIGS. 8A-E, the fluid tubes 808A-F connect internally to each separate solenoid valve through suitable internal structure and are held together by a suitable connector 816 that mates with a receptacle 820 on the cover or top panel 812. The housing 800 has ends 824 and 828, as well as sides 832 and 836. While the housing 800 is shown to be a combination of several parallel-piped shapes, it may also be in other shapes or forms to accommodate the design of the products involved. It may be noted that a suitable detent 825 and a flexible snap connector 827 are provided for effecting a secure but removable mechanical connection of the base 840 to the housing 800. Of course, any other means to effect a mechanical association desired by the user will suffice.

The top panel 812 is affixed to the housing 800 by any suitable means to effect a secure but removable connection sufficient to withstand the forces to effect repeated connection and disconnection of the connector 816. In this arrangement, the top panel 812 is held in place by screws that are positioned through strengthened receptacles 813A-H. The screws extend into suitable plastic receptacles (not shown) in the housing 800.

The connector 816 is removably connected to a receptacle 820 and held in place by any means that permits the connector 816 to be held securely in place and easily removed. In FIGS. 8A-E, the receptacle 820 has snap connectors 829 and 823 that move outwardly as the connector 816 moves into place and then move inwardly toward a lip or rim 821 on the connector 816 to hold the rim 821 and in turn the connector 816 in place. Thus, the connectors 829 have a first position in which they are tensioned toward the connector 820 with a shoulder that mechanically extends over the rim 821. The user may urge the connectors 829 and 823 outwardly so the shoulder is no longer mechanically engaged with the rim 821 so the user may then remove the connector 816.

The solenoid valves that are in and that include the housing 800 use actuators comparable to actuators 900A-F of FIG. 9 positioned within the housing 800. The housing 800 acts as a protector and as an insulator. The housing 800 also has a base 840 that holds the solenoid valves inside. The solenoids are mounded to a circuit board comparable to those discussed and described in connection with the valve assembly of FIG. 9. In FIG. 8C, a suitable electrical connector 839 is shown for receiving a connector for electrical connection to a suitable controller like controller 200 or the valve controller 275 (FIG. 7) which is operated by controller 19 (FIG. 1).

Referring now to FIG. 9, an exploded perspective view of an embodiment of an alternate valve assembly 900 is shown. As depicted in FIG. 9, it has a receptacle 916 positioned in a side orientation as compared to the receptacle 820 of FIG. 8A. Space considerations in particular installations may dictate the choice of the arrangement depicted in FIG. 8A or FIG. 9. In other words, different configurations of the housing 800 may be provided to deal with space and particularities of particular installations. Thus, variations are within the scope of the embodiments described herein.

With further reference to FIG. 9, a plurality of solenoid actuators 900A-F are illustrated. The solenoid actuators 900A-F have valve members 901A-F that interface with a suitable valve seat inside the housing 901. As can be seen in FIG. 9, the housing 902 has a front 906, a back 908, and opposite sides 910 and 912. It also has a top 914 that is configured differently from the top 812 of FIG. 8A. That is, top 914 is configured with a chamber body 918 that has a receptacle 916 affixed to a side 919 of the chamber body 918. The connector 921 has a plurality of tubes 920A-F extending there from for connection to separate chambers of a device having multiple inflatable chambers. Each of the plurality of tubes 920A-F connects by suitable means within the connector 921 for connection to individual discharge ports 924A-F. The individual discharge ports 924A-F are connected by internal channeling to an inlet that receives low pressure fluid such as air at a pressure of less than 5 pounds per square inch and preferably about 0.5 pounds per square inch via inlet 926. The valve members 901A-F are configured to operate between an open position is which air is supplied to or vented from the chambers and a closed position inhibiting the flow of low pressure fluid through (in and out of) the discharge ports 924A-F.

The chamber body 918 has a separate cap 927 that is affixed by any suitable means such as screws, clamps, detents, or the like sufficient to effect a sealed relationship. A separate gasket may be provided to facilitate the seal.

The chamber body 918 also has a connector 928 that is affixed to a mounting board 930 that has wiring or circuits to connect to the individual actuators 900A-F. The valve assembly 900 and, in turn, the actuators 900A-F may be wired directly to a controller like the controller 200 through connector 928 and wires 929. Alternately, the actuators 900A-F may be connected by a wireless communication device (not shown).

In operation, the solenoid actuators 900A-F may position the valve members 901A-F in a first position to allow the inflation of its associated inflatable chamber. Thus, the valve members 901A-F move to port the fluid such as air from a source to a selected conduit of the conduits shown 920A-F. In the same position, the fluid such as air may be vented from the conduits 920A-F to a reservoir or the atmosphere. In a second position, the actuators 900A-F position the valve members 901A-F in a closed position substantially prevent fluid flow to and from the inflatable chamber. U.S. Pat. No. 6,439,264 (Ellis, et al.) discloses one valve assembly that could be adapted to this purpose so that the disclosure thereof is incorporated herein by reference in its entirety for all purposes.

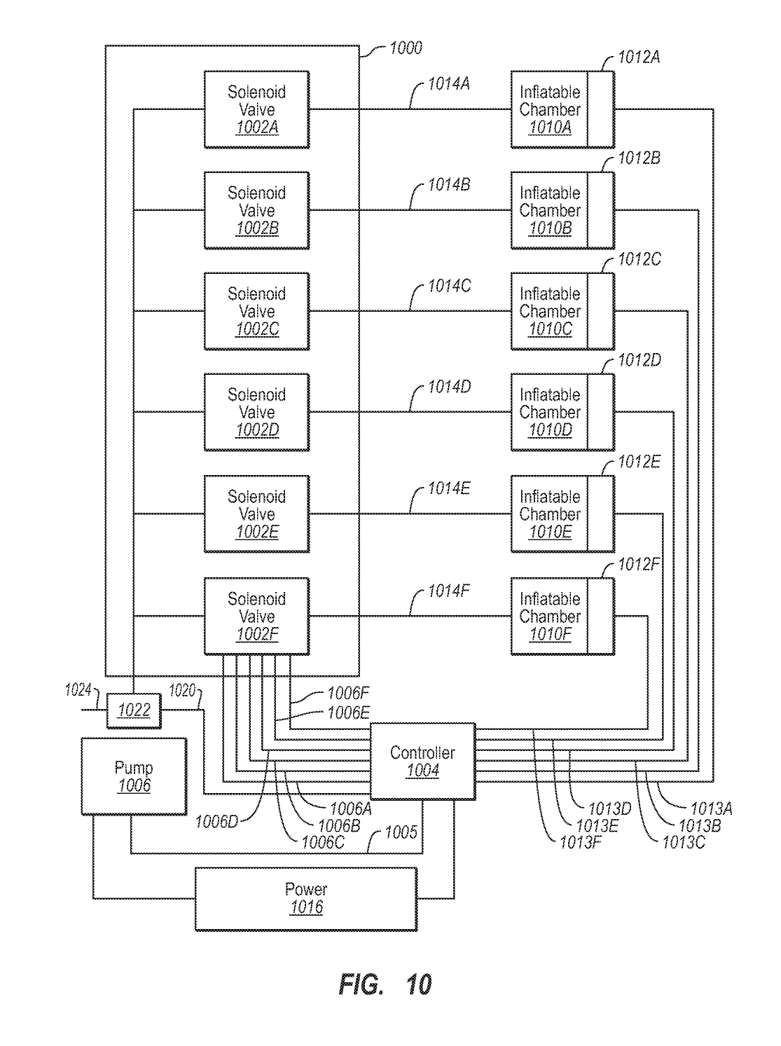

The mounting board 930 and the individual actuators 900A-F are held in the chamber body 918 by a bottom plate 932 that is configured to be held in place by a mechanical button 909 and a deflectable tab (not shown) comparable to the arrangement used in FIGS. 8A-E. Alternately, one may use screws for connecting the bottom plate 932 to the housing 902. The connector 918 is connected to the controller 200 in FIG. 10 via wires 929 suitably bundled to receive operating signals there from. The solenoid actuators 900A-F are each mounted to the circuit board 931 that is configured to supply power from connector 928 to each of the solenoids actuators 900A-F. The actuators 900A-F are held to the circuit board 930 by brackets 902A-F. That is, the brackets 902A-F are soldered to the board 931; and brackets 902A-F along with the board 931 and the actuators 900A-F are sized to fit into the housing 902 and to be held therein by bottom plate 932.

Referring now to FIG. 10, a block diagram of an embodiment of a valve assembly 1000 comparable to valve assembly 215 (FIG. 7) is shown. The valve assembly 1000 includes, but is not limited to, six solenoid valves 1002A-F. The controller 1004 is comparable to controller 200 and controller 19 and provides operating signals to the pump 1006 (comparable to pump 210 of FIG. 7) via conductor 1005. The pump 1006 provides pressurized fluid like air to the valve assembly 1000 via suitable tubing 1008.

The controller 1004 of FIG. 10 is also in communication with solenoid valves 1002A-F to selectively operate them to maintain a desired level of inflation (i.e., pressure of pressurized fluid in a corresponding number of inflatable chambers 1010A-F). The pressure of the pressurized fluid in each of the inflatable chambers 1010A-F is monitored by suitable means which in this embodiment is a flexible potentiometer 1012A-F associated with each inflatable chamber 1010A-F. Signals reflective of the pressure in each inflatable chamber 1010A-F from each flexible potentiometer 1012A-F are determined by measuring the deflection of the chamber wall between conditions where it is inflated more and inflated less. Such signals are supplied to the controller 1004 by conductors 1013A-F connected to the sensors 1012A-F. The solenoid valves 1002A-F are operated by the controller 1004 to supply the pressurized fluid through lines 1014A-F to maintain the desired pressure in each of the inflatable chambers 1010A-F. Power is shown being supply from a source 1016 to the controller 1004 and pump 1006. Power is also supplied to the flexible potentiometers 1012A-F that sense the deflection of the inflatable chambers 1010A.-F respectively. Power is also supplied to each of the solenoid valves 1002A-F from the controller 1004 via conductors 1006A-F.

The controller 1004 also supplies a signal to the vent valve 1022 via conductor 1020. The vent valve 1022 has a first position in which it ports fluid (e.g., air) from the pump 1006 into tubing 1008. In a second position, the vent valve 1022 ports fluid (e.g., air) from the tubing 1008 to a vent line 1024. The vent line 1024 vents fluid such as air to the atmosphere or is connected to vent the fluid that is to be saved or recycled to a reservoir (not shown). Thus, to inflate inflatable chambers 1012A-F, the solenoid valves 1002A-F are opened with the vent valve 1022 oriented to port air from the pump 1006 to the tubing 1008. Of course, the pump 1006 is operated until the detectors such as flexible potentiometers 1012A-F move with the chamber to a position indicative of fully inflated. When the inflatable chambers 1010A-F are fully inflated, the controller turns off the pump 1006 and closes the solenoid valves 1002A-F. If one or more of the chambers 1010A-F becomes over inflated, the controller opens the associated solenoid valve 1002A-F and operates the vent valve 1022 to the vent position to supply the fluid from the tubing 1008 to a reservoir or to the atmosphere.

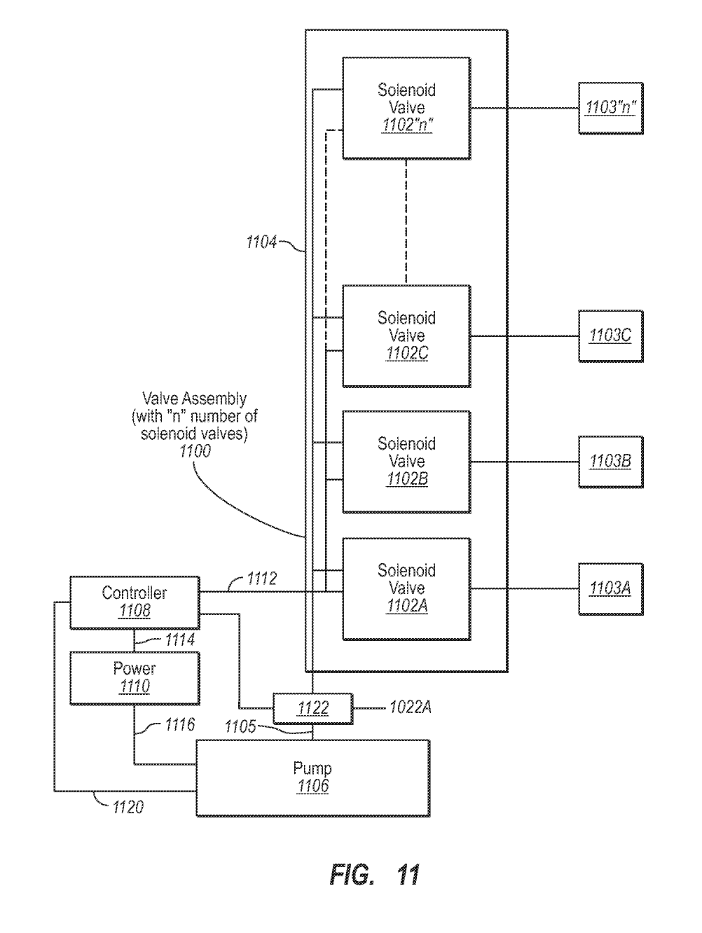

With reference now to FIG. 11, a valve assembly 1100 is shown that has “n” number of solenoid valves 1101A to “n”. That is, the valve assembly 1100 may have or include any number of solenoid valves up to the number “n” where “n” is any number from 1 up to perhaps 30 to 40. The total number “n” of solenoid valves intended can vary based on manufacturing and installation costs and specifications. In other words, it is possible to have one valve assembly 1100 with an array of solenoid valves for each chamber 1103A-“n” of a 30-40 chamber device for supporting a person. Practically, valve assembly 1100 with an array of 6, 8, 10 and 12 solenoid valves are expected for desired applications. Each solenoid valve 1102A-“n” receives a fluid such as air under pressure from a source via supply lines 1104. The source is here shown to be a pump 1106. The pump 1106 and an associated controller 1108 as well as the solenoid valves 1102A-“n” all receive power from a power supply 1110 via suitable conductors 1112, 1114 and 1116. The controller 1108, in turn, supplies control signals to the pump 1106 via conductor 1120, to the solenoid valves 1102A-“n” and to a vent valve 1122. When it is desired to inflate chambers 1102A-“n”, the pump 1106 is operated to supply fluid through the vent valve 1122 which is positioned to port the fluid from the pump 1106 to each of the solenoid valves 1102A-F which, in turn, selectively are operated to supply air to the chambers 1103A-“n”. When it is desired to reduce the air in a chamber 1103 A-“n”, its related solenoid valve 1102A-“n” is positioned so that air may flow back to the vent valve 1122 and out vent 1122A. The vent 1122A may be directed to vent in a variety of locations and may be sized to fit system performance requirements. Other elements of the valve assembly are not repeated and are consistent with other embodiments described herein.

Referring now to FIG. 12, a mattress 1200 of a mattress support system is shown having a plurality of “n” inflatable chambers 1201-1230. That is, the mattress 1200 has “n” chambers where any number up to at least 30. In one arrangement, the pressure within each of the inflatable chambers 1201-1230 can be separately adjusted one at a time. In other arrangements, the pressure within the inflatable chambers 1201-1230 can be adjusted in pairs or patterns to achieve desired purposes. For example, chambers 1201, 1202 and 1227-1230 can be controlled to create more rigid exterior portions in comparison to the chambers 1203-1226 which can be inflated or deflated in patterns as desired. For example, one could arrange to have all odd numbered chambers (e.g., 1203, 1205) inflated on day 1 with all even numbered chambers deflated. On day 2, the inflation and deflation can be reversed with all even numbered chambers inflated and all odd numbered chambers deflated. In short, the controller like controller 1108 can control the rigidity (e.g., air pressure) and the pattern to achieve multiple desired therapeutic benefits. In other words, the solenoid valves 1102A-“n” can be operated to vary at least inflation pressure, the length or time of inflation, the pattern, and/or with two or more of the inflatable chambers 1201-1230 deflating substantially simultaneously, sequentially, serially, or as desired, and/or with two or more of the inflatable chambers 1201-1230 neither inflating nor deflating.

As with the mattress support systems described herein, each inflatable chamber 1240 can be independently or separately inflated or deflated. In addition, because a valve assembly and vent valve comparable to that disclosed herein is used, fluid flow can be controlled to flow to and flow from multiple chambers. To be able to simultaneously inflate or deflate multiple chambers, the systems may be reconfigured to have a vent valve comparable to vent valve 1105 in each or conduit going to each solenoid valve. That is, the controller such as controller 1104, or 1108 provides instructions to each independently controllable solenoid valve and vent valve associated with each inflatable chamber 1240 to allow fluid flow into or out of the corresponding inflatable chamber 1240, or to otherwise prevent fluid flow into or out of each inflatable chamber 1240. The chair or seat support systems described herein may alternatively be used with the valve system described in U.S. Pat. No. 7,219,380, the content of which is incorporated herein by reference in its entirety for all purposes.

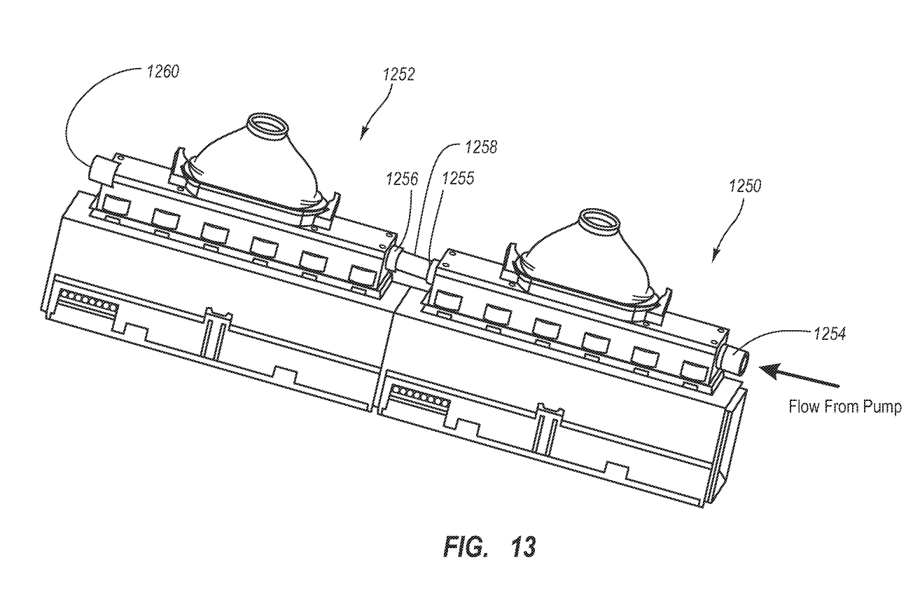

Referring now to FIG. 13, a plurality of valve assemblies 1250 and 1252 are shown joined together. Such a system of valve assemblies 1250 and 1252 allows for modular manufacture of valve assemblies having a desirable number of solenoid valves therein. The valve assemblies can be added together, such as in series, to provide the requisite number of solenoid valves for corresponding to a support system having a corresponding number of inflatable chambers. As shown, the exemplary embodiment of valve assemblies 1250 and 1252 depicted in FIG. 13 include an inlet port 1254 and an alternate inlet port 1256. Both ports are in communication with an interior inlet plenum. The outlet port 1255 of valve assembly 1250 is in fluid communication with an inlet port 1256 of valve assembly 1252. A simple connector tube 1258 is contemplated. Valve assembly 1252 may further include an outlet port which is covered by an end cap 1260.

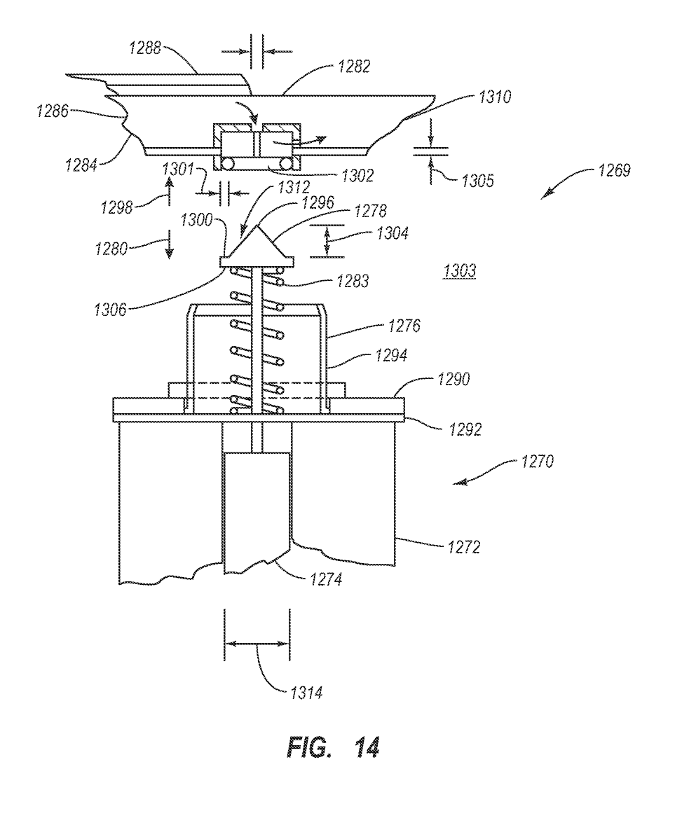

Turning now to FIG. 14, a solenoid valve 1269 has a solenoid 1270. The solenoid is cylindrical and shown in cross section to have a stator 1272 that receives electricity to create a magnetic field that interacts with the armature 1274 to move the armature 1274 and, in turn, the valve stem 1276 and valve head 1278. In the illustrated embodiment, the stator 1272 is activated by a controller causing the armature 1274 to move down 1280 thereby compressing spring 1283 and removing the valve head 1278 from the opening 1282 in the interior of the housing 1284 which is comparable to housing 800 and 902. The housing 1284 has been formed to have multiple chambers that includes an inlet plenum 1286 that is receiving fluid from a source (e.g., a pump) through intake port 804. From the inlet plenum 1286, the fluid passes through the opening 1282 into an interior plenum 1288 which is in communication with a suitable outlet such as outlet 924A-F (FIG. 9) through discharge port 1308 and discharge plenum 1310. It may be noted that the opening 1282 is typically a round hole and sized to regulate the flow of the fluid (like air) there through. The fluid is then supplied under pressure through the conduits like tubes or conduits 808A-F (FIG. 8E) to a suitable inflatable chamber (FIG. 4).

The solenoid 1270 of FIG. 14 has a bracket 1290 that is comparable to brackets 902A-F (FIG. 9). An insulating spacer 1292 made out of a suitable non conductive material like plastic provides for a snug fit within the bracket 1290. A hollow housing 1294 extends upward from the insulating spacer 1292. The housing 1294 is cylindrical and has within it the valve stem 1276 and the compressing spring 1283. The housing 1294 protects the valve stem 1276 and the compressing spring 1283. The valve head 1278 is conical in shape with a tip 1296 that is positioned to register with and close the opening 1282 when the solenoid 1270 is deactivated. That is, when the solenoid 1270 is deactivated, the compressing spring 1283 urges the valve head 1278 upward 1298 into registration with the opening 1282 to close the opening 1282. The valve head 1278 has a collar 1300 having a width 1301 that engages an “o” ring 1302 if about the same width 1301 to effect a seal with the interior 1303 of the valve. The height 1304 of the valve head 1278 is selected so that the tip 1296 seals the opening 1282 while the collar 1300 engages the “o” ring 1302. A double seal is thereby effected. Of course, when the valve opens, the head 1278 moves down 1280 so that the fluid may come through the opening 1282 and pass through a discharge port 1308 into a discharge plenum 1310. The discharge port 1308 is formed to be larger in cross section than the opening 1282 so that the discharge port 1308 does not restrict flow.

As noted, the fluid such as air in the inlet plenum 1286 is at a pressure typically less than 5 psi and, in this embodiment, less than 1.0 psi. Preferably, the fluid is at a pressure of around 0.5 psi. This is a very low pressure so that the amount or volume of air that flows through the hole or opening 1282 is relatively small and at a relatively low flow rate. Thus, the risk of plugging the hole with dirt or even ice is reduced because the drop in pressure across the opening 1282 is relatively small.

It may also be noted that the solenoid valve 1269 is normally closed. That is, when there is no electrical power supplied to the stator, there is no magnetic force or field to move the armature. In turn, the spring closes the solenoid valve 1269. Thus, a loss of electrical power causes the valve to close and maintain the status quo until electrical power can be restored. The solenoid valve 1269 is also a safety valve. The pressure of the fluid in the discharge plenum 1310 and, in turn, in the inflatable chambers is pressing down on the effective surface 1312 of the valve head 1278 having a diameter 1314. The compressing spring 1283 must have sufficient strength or hold the valve closed with the pressure above normal expected pressures. In the illustrated embodiment, a pressure of 10 psi in the discharge plenum means that the force needed to hold the valve head 1278 in place must be about over 2 pounds. Notably, if someone were to, for example, jump on an inflatable chamber or place a huge weight on it suddenly, one could experience a spike in pressure that could damage the inflatable chamber. However, with a valve structured as in FIG. 14, a spike in pressure will force the valve head 1278 down 1280 and open the discharge plenum to the interior 1303 of the valve. Thus, pressure will be released to the interior 1303 of the valve and potentially out around the connector 928 (in FIG. 9) to the atmosphere. Thus, the solenoid valve 1269 in effect acts as a safety valve.

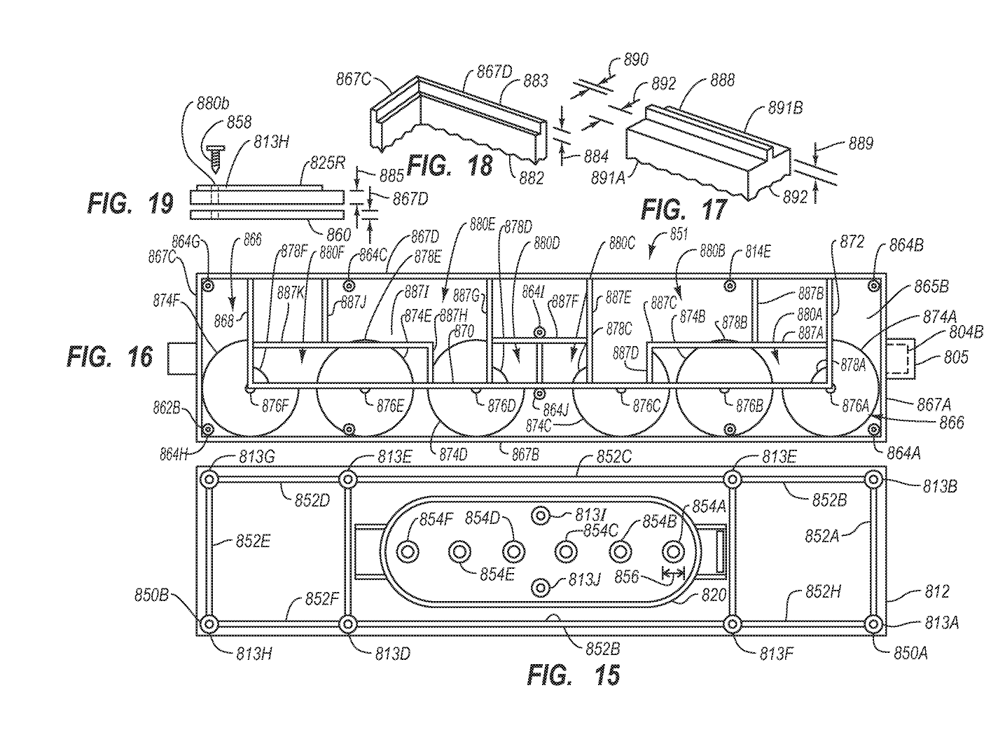

Turning to FIG. 15, the cap or top panel 812 of the valve assembly 215 of FIG. 8A is shown in greater detail and is enlarged over actual size. The top panel 812 includes a plurality of screw receptacles 813A-J each having a predrilled aperture. Only two of the apertures 850A and B have been marked in this drawing to simplify the drawing. However, all have been illustrated. Stiffeners 852A-H are shown extending between the several receptacles 813A-J to strengthen the top panel 812 and minimize or reduce the risk of cracking upon assembly of the top panel 812 to the upper portion of the housing 800 as discussed hereinafter.

The top panel 812 is shown with the receptacle 820 having 6 exit ports 854A-E each cylindrical in shape and sized in diameter 856 (e.g., 3.5 millimeter) to snuggly either receive an elastically deformable plastic tube or a connector 816. The plastic tubing (e.g., TYGON® tube) if used is suitably sized (e.g., about 6 millimeters outside diameter and about 3 millimeter inside diameter) to transmit the fluid between the valve assembly 215 and the inflatable chambers. The inside diameter of the tubing may be changed based on the conductance requirements of a given application.

The top panel 812 is assembled to the housing 800 and, more particularly, to the upper portion 851 of the housing 800 using screws like screw 858 that threads into the hole 850B and through gasket 860 (FIG. 19) and into the corresponding hole 862B in the upper portion 851 of the housing 800. An optional hole like hole 862A and 862B is formed in each of the screw receptacles 864A-J. To avoid clutter in the illustration, only two holes 862A and 862B are numbered. However, all are illustrated.

The upper portion 851 of the housing 800 has an inlet plenum 866 formed in part by a floor 865B which is an extension of the surface 865A of the lower portion of the housing 800. The plenum 866 is also formed in part by exterior walls 867A-D and interior walls 868, 870 and 872. The plenum 866 is further formed by the top panel 812 when it is secured in place. Raised cylindrical portions 874A-F each extend 1305 a distance of about 5 to 10 mm from the floor 865B similar to the portion 1307 (FIG. 14). The raised cylindrical portions 874A-F have a central aperture 876A-F each formed to register with the tip of the valve head comparable to tip 1296 of valve head 1278 in FIG. 14. The apertures 876A-F are each in communication with the inlet plenum 866 to receive pressurized fluid there from. When a valve head is in an open position, the pressurized fluid passes from the plenum 866 through the related aperture of the apertures 876A-F. The pressurized fluid then proceeds into its respective outlet of the outlets 878A-F. Each of the outlets 878A-F is in fluid communication with a separate chamber 880A-F that aligns with one of the exit ports 854A-F. In turn, when all the valve heads are in their open position, pressurized fluid passes from the plenum 866 through respective apertures 876A-F and into their respective ports 878A-F, then into their respective chambers 880A-F and then exit ports 854A-F (FIG. 12). Fluid enters the plenum 866 through intake port 804. An alternate inlet 804B is shown with a cap 805 securely positioned thereof. The cap 805 can be removed to effect interconnection with an adjoining valve assembly as shown in FIG. 13.

The outer walls 867A-D are formed to have a ledge 882 formed and sized as shown in FIG. 18. The ledge 882 has back 883 that has a height 884 to accommodate the height 885 or thickness of the top panel 812 and the height or thickness 886 of the gasket 860 so that when the gasket 860 and the top panel 812 are assembled using screws like screw 858 that extend through apertures like apertures 850A and 850B into apertures like apertures 862A and 862B. Notably, the gasket 860 and top panel 812 are sized to fit snuggly into the notch formed by the ledge 882 and back 883.

As the gasket 860 is urged against the ledge 882 to effect a seal, the separate interior walls 868, 870 and 872 as well as walls 887A-K are shaped to effect a seal. Notably, the top of each wall 868, 870 and 872 as well as wall 887A-F each are formed to have a ridge 888 having a height 889 of about 0.5 millimeters and width 890 of about 0.5 millimeters. The ledges 891A and 891B each have a width 892 of about 0.5 millimeters. Thus, the ridge 888 presses into the gasket 860 which is made of an elastically deformable material such as a closed sell neoprene. Thus, the ridge 888 is sized so that when the top panel 812 is properly installed, the ridge 888 is urged against the gasket 860 to form a seal.

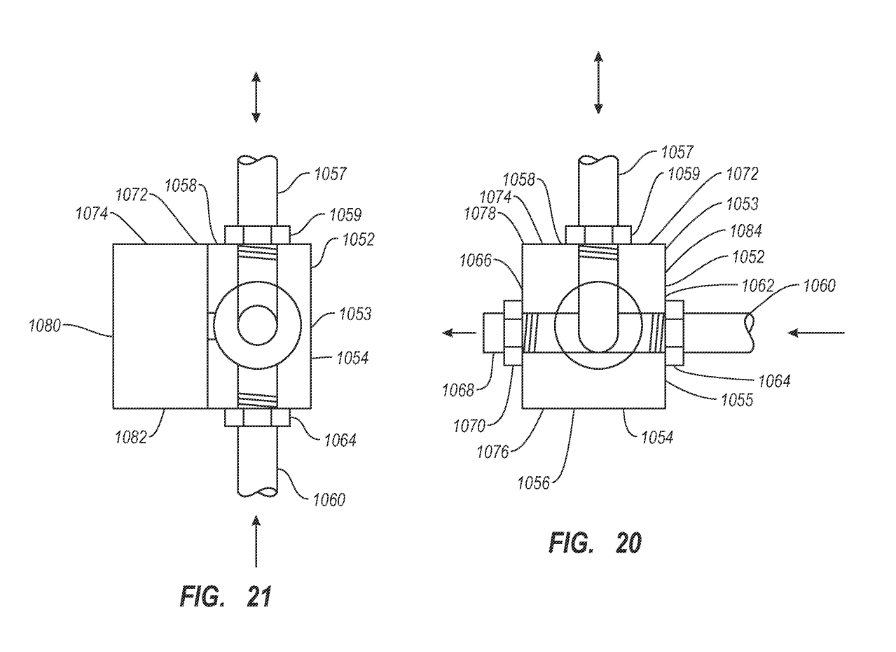

A vent valve 1050 suitable for use as vent valves 1022, 1122 and 216 is depicted in FIGS. 20 and 21. The vent valve 1050 has a housing 1052 in which a central cavity 1053 is formed. The central cavity 1053 is typically lined with a low friction material such as Teflon® and sized to hold a ball 1054. The low friction material allows for ease in rotation of the ball 1054 between a first position 1055 shown in solid and a second position 1056 shown in dotted line. A suitable conduit 1057 interconnects to the inlet port like intake port 804 (FIG. 8A) of a valve assembly 215 to a first port 1058 formed in the housing 1052. The conduit 1057 is any suitable tubing that is connected to the housing 1052 by use of compression nut 1059 or similar fastening arrangement suitable for effecting a sealed connection for the pressurized fluid. The first port 1058 communicates directly with a housing channel 1072 which aligns with a first ball channel 1074 formed in the ball 1054. The first ball channel 1074 connects with a second ball channel 1076 which aligns with vent channel 1078. In effect, the first ball channel 1074 and second ball channel 1076 intersect at an angle which is here a angle of about 90 degrees. Thus, as the ball rotates about 90 degrees, it rotates the ball 1054 and, in turn, first channel 1074 and second ball channel 1076 into alignment with different internal channels as discussed hereinafter.

A conduit 1060 may also be any suitable form of tubing including flexible tubing extends from a pump (like pump 1006 (FIG. 10)) that supplies pressurized fluid to a second port 1062. The conduit 1060 is connected to the second port 1062 and held in place by a compression nut 1064 or the like. A simple friction fit may be suitable given the low pressure of the pressurized fluid. A third port 1066 is formed in the housing 1052. A vent pipe 1068 is attached to the third port 1066 by a suitable compression nut 1070 or friction fit. In lieu of a vent pipe 1068 that vents to the atmosphere, a pipe (not shown) may connect to a reservoir to receive and retain fluid from the system. The third port 1066 is aligned with and in communication with the vent channel 1078.

In operation, the vent valve 1050 is rotated by a suitable solenoid or stepping motor 1080 having a rotatable armature that is connected to the ball 1054 by a shaft 1082. Upon application of suitable electrical signals, the solenoid or stepping motor 1080 rotates, in turn, rotating the ball 1054 between its first position 1055 and its second position 1056. In the first position 1055, the ball 1054 is positioned to connect the valve assembly inlet plenum 866 (FIG. 16) to the vent pipe 1068 through conduit 1057, first port 1058, housing channel 1072, first ball channel 1074, second ball channel 1076, and vent channel 1078. Thus, any one or more inflatable chambers can be connected to vent pressurized fluid by opening its associate solenoid valve in the applicable valve assembly and by aligning the vent valve 1054 ball in its first position 1055. The solenoid or stepping motor 1080 can be activated to rotate the ball 1054 to a second position 1056 in which the first ball channel 1074 is aligned with the inlet channel 1084 and the second ball channel 1076 is aligned with the housing channel 1072. Thus, pressurized fluid may flow from a pump like pump 210 in FIG. 7 through conduit 1060, second port 1062, inlet channel 1084, first ball channel 1074, second ball channel 1076 and then into housing channel 1072, first port 1058 and conduit 1057 for further delivery to a valve assembly like valve assembly 215. Of course, from the valve assembly, the pressurized fluid is eventually supplied to one or more inflatable chambers.

Referring back to FIG. 7, controller 200 in operation receives deflection signals reflecting the deflection of one and all of the flexible potentiometers 235a-f located on at least one surface of the inflatable chambers 220a-f. In other words, the controller 200 has a reading circuit 270 coupled to flexible potentiometers 235a-f. At prescribed periods of time, reading device 270 receives deflection signals from flexible potentiometers 235a-f. For example, if an individual's body is resting on inflatable chambers 220a-f, the flexible potentiometers 235a-f detect deflection on each inflatable chambers 220a-f, respectively by changing the electrical resistance and, in turn, the voltage or the electrical current therethrough based on the classic formula known as Kirchhoff's law. In response, a deflection signal is transmitted from flexible potentiometers 235a-f to the reading circuit 270 in controller 200 which may be any known A to D converter. Reading circuit 270 then forwards the converted deflection signals to processor 205 which, in turn, applies suitable logic programmed to cause the valve assembly 215 and vent valve 216 to operate to inflate or vent or hold as warranted.

Processor 205 may use the deflection information from flexible potentiometers 235a-f in a variety of ways. For example, the deflection information provides processor 205 with information regarding the position of a human body on inflatable chambers 220a-f. Processor 205 may then instruct controller 200 to alter the pressure within the interior volumes of one or more inflatable chambers 220a-f at prescribed intervals to vary the pressure exerted from the surface of the inflatable chambers on the skin of the individual, thereby reducing the formation of bedsores.

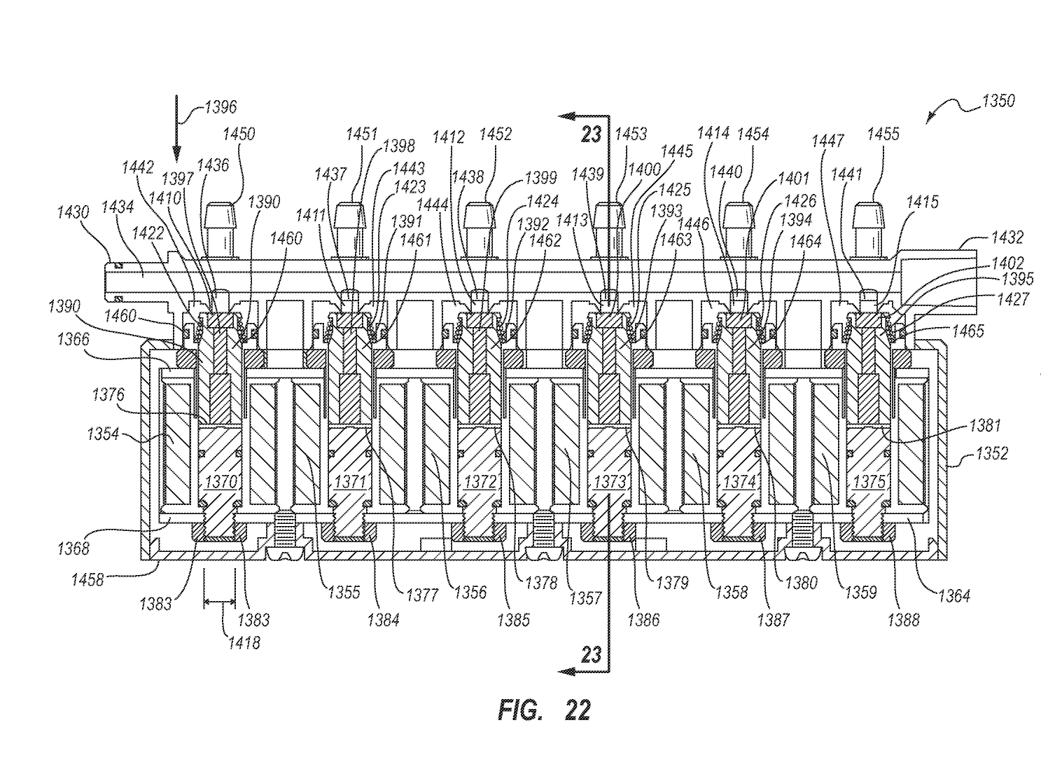

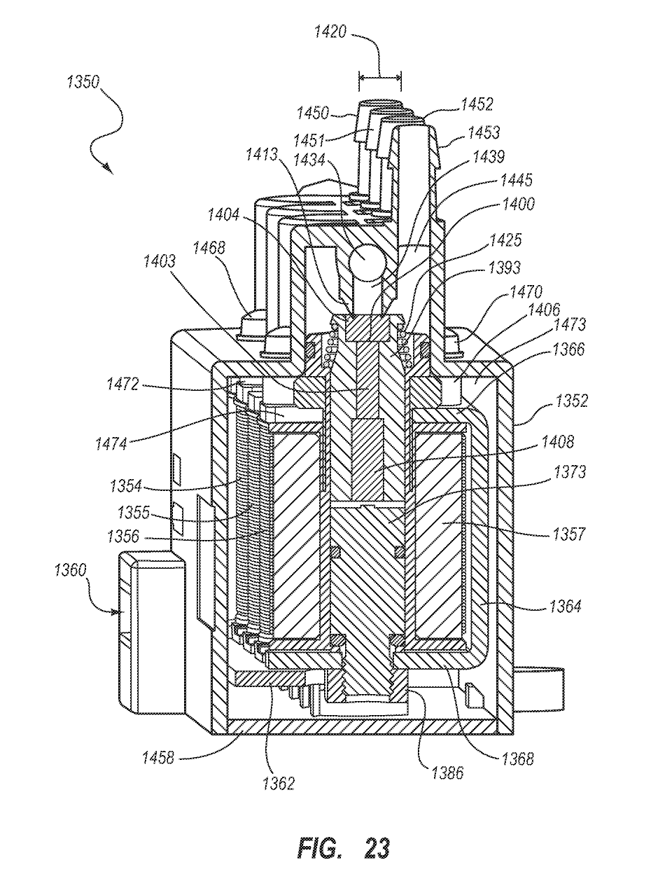

Referring now to FIGS. 22 and 23, an alternate form of valve assembly 1350 is depicted having a housing 1352 within which are positioned a plurality of solenoid valves for porting fluid such as low pressure air to and from the separate inflatable chambers of a support device for supporting an occupant or user positioned on the support device. The solenoid valves each have a coil or armature 1354-59 that is powered electrically. That is, electrical power is delivered from a suitable source through a connector 1360 that is configured to supply power to the separate armatures 1354-59 through conductors formed on a suitable printed circuit board 1362. The armatures 1354-59 are placed in a C-shaped bracket 1364 that has a top member 1366 and a bottom member 1368. Within each armature 1354-59 is a core stabilizer 1370-75 that is sized to snuggly fit within a core channel 1376-81. Each stabilizer 1370-75 has a threaded extension to which a nut 1383-1388 is affixed to hold the stabilizer 1370-75 in place attached to its respective C-shaped bracket like the C-shaped bracket 1364. The stabilizers 1370-75 are sized to fit snuggly in their respective core channels 1376-81 and are sealed in place by O-rings like O-rings 1382A and 1282 B.

Above each stabilizer 1370-75 is a separate and movable core 1390-95. Each core 1390-95 is a cylinder formed from a suitable metal that is of the type that can be moved by a magnetic force generated by the armatures 1354-59. Each of the armatures 1354-59 are configured to urge its respective core 1390-95 downward 1396 toward their respective stabilizers 1370-75.

Each core 1390-95 has a central section 1397-1402 that is milled out and filled with a filler 1403 that is elastically deformable and essentially inert such as silicon or rubber, teflon (polytetrafluoroethethylene), nylon and various polyethylene terephthalate (PET) materials. The filler 1403 has been numbered only in FIG. 23 for simplicity.

As can be seen in FIG. 23, the central section 1397-1402 of each core 1390-95 has an upper large diameter portion 1404, a narrow or thin diameter portion 1406 and a large diameter portion 1408. When the filler 1403 is poured into the central section 1396 of each core 1390-95, it sets up and when solidified, cannot be easily pushed out of its respective central section 1397-1402 because the different diameters create ledges that act to restrict the movement of the filler 1403.

Each core 1390-95 is urged against a valve seat 1410-1415 that may be flat and sized in diameter 1418 to be less than the diameter 1420 of large diameter portion 1408 of the filler 1402. The cores 1390-95 are each urged toward their respective valve seats 1410-1415 by a respective spring 1422-1427. If the surface of the valve seat 1410-1415 is flat, it will be urged into the filler 1402 which will deform sufficiently to effect a seal. Preferably, the valve seats 1410-1415 have a circular edge that is somewhat sharp. In turn, the seat 1410-14 is more easily urged into and farther into the filler, like filler 1403, to effect a better, tighter seal.

The fluid such as air is supplied to the valve assembly 1350 from an external source through one of two ports 1430 and 1432. The fluid then proceeds through the line 1434 to the valve seats 1410-1415 through channels 1436-1440. When a solenoid is activated, the armature like armature 1357, its core like core 1393 is urged down 1396 with strength or force sufficient to over come the force of the spring 1425 to, in turn, cause the valve to open and port the fluid, like low pressure air from the line 1434, into its respective plenum 1442-1447 which is in direct communication with its respective outlet ports 1450-55. Suitable tubes are connectable to the outlet ports to supply fluid such as air to and from inflatable compartments of a supporting device.

The valve components are held in the housing 1352 by a base 1458. Suitable snap connections or screws can be used to effect the connection and to allow access for maintenance. A suitable o-ring structure 1460-65 are provided to effect a seal and the formation of the plenums 1442-1447. In the configuration of FIGS. 22 and 23, four screws are used to pull the C shaped bracket into the housing 1352 of which three screws 1468-70 (FIG. 23) can be seen interconnecting to receivers 1472-74.

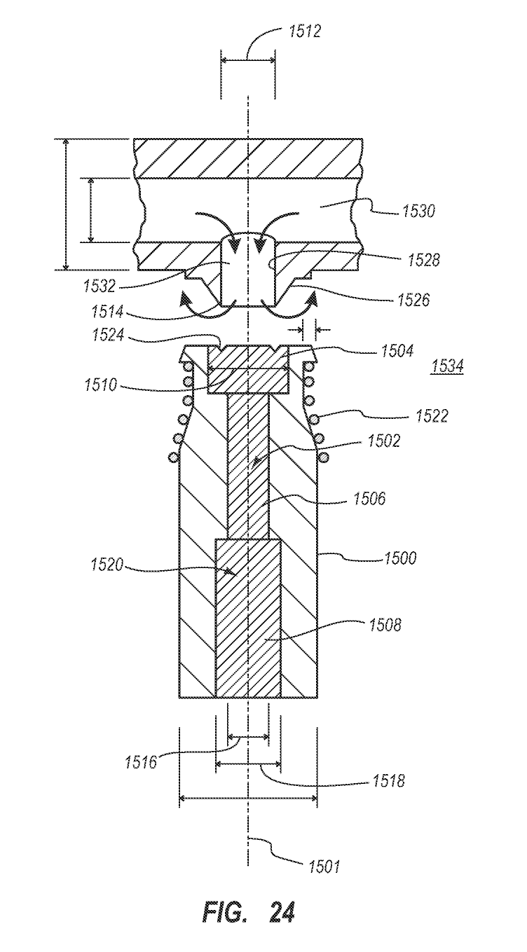

FIG. 24 is a simplified cross sectional view and enlarged to illustrate the relationship between the core 1500 that is movable by a solenoid like one of the solenoids 1354-1359 of FIGS. 22 and 23. The core 1500 moves to abut the valve seat 1514 as more fully discussed hereafter. The core 1500 has a bore 1502 that is formed along the central axis 1501 of the core 1500. The bore 1502 is here formed to have an upper large diameter section 1504, a small diameter section 1506 and a large diameter section 1508. The large diameter section 1504 has a diameter 1510 that is selected to be larger than the diameter 1512 of the valve seat 1514. The diameter 1510 is also larger than the diameter 1516 of the small diameter section 1506. The diameter 1518 of the section 1508 is more than the diameter 1516 and may be less than or more than the diameter 1510. It may be noted that in some applications, a single bore of uniform diameter or cross section (if not circular in cross section) may be sufficient. In other applications, multiple or different diameters may be preferred to inhibit movement or migration of the filler 1520 through the bore 1502 in use.

The bore 1502 is filled with a filler 1520 that is elastically deformable and preferably essentially inert when cured. That is, the filler 1520 is preferably a material that can be prepared in liquid form and poured or injected into the bore 1502 where it cures and, in turn, hardens. When it is cured or hardened, it is elastically deformable. The spring 1522 is positioned to urge the core 1500 upwardly toward and against the valve seat 1514. Because the filler 1520 is elastically deformable, the valve seat 1514 is urged into the filler 1520 based on the strength of the spring 1522 to create a dent 1524 or depression in the filler 1520 thereby creating or effecting a seal as the filler 1520 presses up and against the sides 1526 and 1528 of the valve seat 1514. While the valve seat 1514 shown has a sharp edge, it should be also understood that the valve seat 1514 may be flat or have a rounded or acute edge. So long as the seat 1514 presses into the filler 1520, it is believed that a seal is formed sufficient to seal so the low pressure fluid in inlet 1530 is sealed from the fluid in the plenum 1534. With the core 1500 in the open position as shown in FIG. 24, air or other fluid may proceed from the line 1530 and through channel 1532 and into a plenum 1534 much like the plenums 1442-47 of FIGS. 22 and 23. Of course, with the solenoid deactivated, the spring 1522 urges the core 1500 back against the seat 1514 to effect a seal. Thus, a lack of power or power failure leads to a closed condition or a fail safe condition.

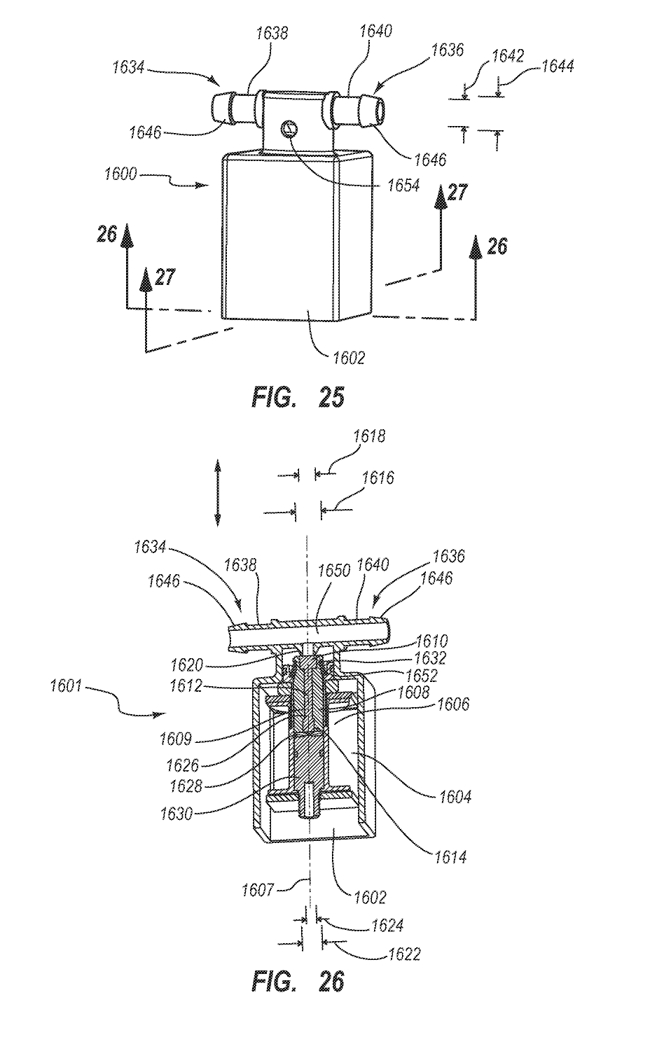

As stated with respect to FIGS. 10 and 11, a system as depicted has a vent valve such as vent valves 1024 and 1122 in FIGS. 10 and 11. In FIGS. 25-27, an alternate and preferred vent valve 1600 is depicted that is configured or structured much like the solenoid valves of FIGS. 22 and 23. The vent valve 1600 has a housing 1602 which a cylindrical coil or solenoid 1604 positioned within. The coil 1604 has a hollow bore 1606 formed along a central axis 1607. The bore 1606 is sized to receive a core 1608 that is here formed to have a hollow cylindrical interior 1609 with an upper large diameter section 1610, a small diameter section 1612 and a lower section 1614. The large diameter section 1610 has a diameter 1616 that is selected to be larger than the diameter 1618 of the valve seat 1620. The diameter 1616 of the large diameter section 1610 is also larger than the diameter 1622 of the lower section 1614. The diameter 1616 of the large diameter section 1610 is more than the diameter 1622 of the small section 1612 and may be less than or more than the diameter 1624 of the lower section 1614.

The interior 1609 of the core 1608 is filled with a filler 1626 comparable to filler 1520 and 1403. The filler 1626 is elastically deformable and preferably essentially inert when cured. That is, the filler 1626 is preferably a material that can be prepared in liquid form and poured or injected into the interior 1609. In order to reduce valve noise and potentially some wear, the filler 1626 in this configuration extends through the interior 1609 and is formed to extend through the interior 1609 and form a cushion 1628. While the cushion 1628 is shown to be cylindrical with a diameter comparable to the diameter of core, it may be in any shape or configuration that is convenient like a button or drop sized sufficiently to elastically deform and to inhibit the contact of the core 1608 with the core stabilizer 1630.

The vent valve 1600 has a spring 1632 that functions comparable to spring 1425 in FIGS. 22 and 23. It is positioned to urge the core 1608 upwardly toward and against the valve seat 1620. Because the filler 1626 is elastically deformable, the valve seat 1620 is urged into the filler 1626 to create a dent or depression sufficient to effect a seal as hereinbefore discussed.

The housing 1602 has a first connector 1634 and a second connector 1636 that are both depicted as a “barb” connector. That is, the connectors 1634 and 1636 have a tubular section 1638 and 1640 that has a diameter 1642 that is comparable to the inside diameter of typical tubing that is used to interconnect components in the system (e.g., ½ inch inside diameter TYGON® tubing). The connectors 1634 and 1636 have a larger diameter 1644 (e.g., 9/16 of an inch to ⅝ of an inch) tapering down 1646 to the tubing inside diameter (e.g., ½ inch). Thus, the tubing can be urged onto the connectors 1634 and 1636 and deform over the taper and the large diameter 1644. The deformation of the tube exerts a force to effect a seal.

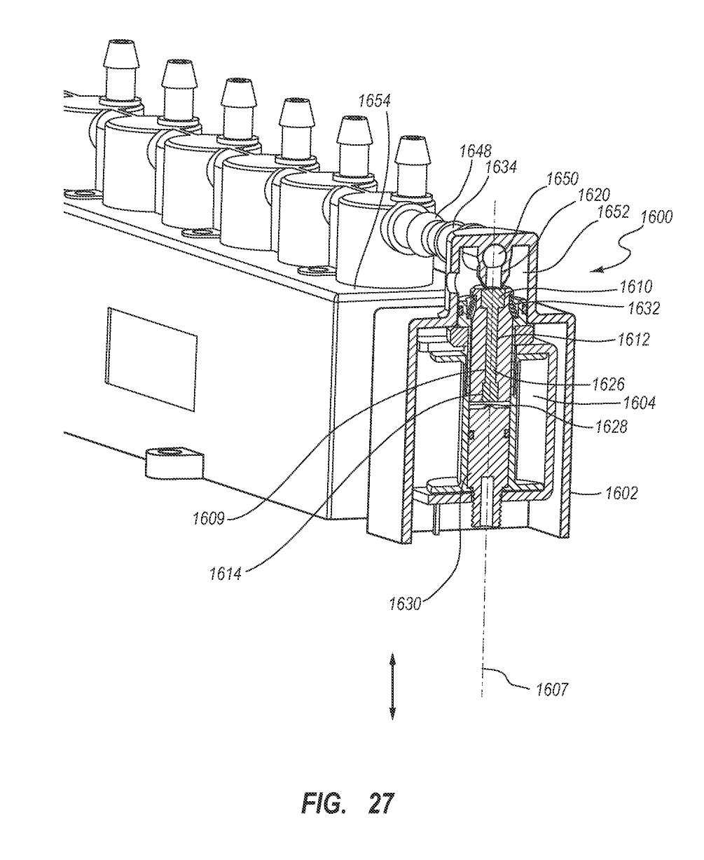

In FIG. 27, the connector 1634 is shown being urged frictionally into a receiver 1648 to effect a connection to the inlet or supply line comparable to line 1434 (FIG. 23). In operation, fluid such as air pressurized at about 1.5 pounds per square inch is supplied in the line for delivery through valves to compartments forming a support surface. With a valve like those in FIGS. 22 and 23, open and the vent valve 1600 closed, air proceeds through the valves FIGS. 22 and 23 to the compartments. To vent air from the compartments, a solenoid valve is placed in the open position. Thus, fluid can proceed from the inflated compartment to the plenum 1442-1449 and then through and valve in the open position with the core 1390-95 displaced from the seat 1410-1415. The air then proceeds into the line like line 1434 to line 1650. Thereafter, the air proceeds past the valve seat 1620 and into the plenum 1652 to the vent hole 1654 which has been sized appropriately (e.g., ⅛ inch to about ¼ inch) to vent with out restriction.

It should be noted that solenoid valves like those shown in FIGS. 22 and 23 as well as vent valve 1600 shown in FIGS. 25-27 also act as relief valves to guard against over pressure conditions in any associated inflated compartments. That is, as the pressure in a compartment increases, that pressure is reflected in the plenums 1442-1449 and, in turn, on the area of the core 1390-95 outward of the seat 1410-1415. With a high enough pressure in the plenums 1442-1449, the force exerted will over come the force of the spring like spring 1425 and, in turn, open the vent valve so that fluid such as air can proceed in the lines 1434 to line 1650 and exert a force on top of the core 1608. When sufficient, it can force the core 1608 down overcoming the force of the spring 1632. In turn, air from line 1650 proceeds into the plenum 1652 and then through the vent 1654 to atmosphere.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An inflatable body support system for supporting a body positioned thereon, said body support system comprising:
a plurality of inflatable chambers each having a flexible wall member having an interior surface and an exterior surface, said wall member being shaped to define an interior volume, each of said plurality of inflatable chambers having a chamber connector for communicating fluid into and out of said interior volume, said flexible wall member being deflectable between a first inflated position and a second inflated position, the second inflated position being different from said first inflated position;
a plurality of flexible potentiometers each of which predictably varies its electrical resistance upon deflection from a first configuration to a second configuration when an electrical signal is applied thereto, each of said plurality of flexible potentiometers being attached to the flexible wall member of one of the plurality of inflatable chambers to move from a first configuration to a second configuration when said flexible wall member moves between said first inflated position and said second inflated position, each of said plurality of flexible potentiometers being configured to generate a deflection signal reflective of movement of the flexible wall member between said first inflated position and said second inflated position;
a fluid source for supplying a fluid under pressure;
a first valve assembly connected to receive fluid under pressure from said fluid source and to said chamber connector for communication of said fluid there between, said first valve assembly comprising a plurality of solenoid valves each configured to receive said fluid under pressure from said fluid source and each connected to at least one of said plurality of inflatable chambers, each of the solenoid valves of said first valve assembly being operable between a first valve position to allow fluid flow to and from said at least one of said plurality of inflatable chambers and a second valve position inhibiting fluid flow to and from the said at least one of said plurality of inflatable chambers;
a plurality of first conduits each connected to said valve assembly on one end thereof and each connected to a said chamber connector of at least one of said plurality of inflatable chambers on the other end thereof, said plurality of first conduits being configured for conveying fluid between each of said the solenoid valves of said valve assembly and at least one of said plurality of said inflatable chambers;
a second conduit connected to said fluid source and to said first valve assembly for conveying fluid from said fluid source to said first valve assembly;
a vent valve positioned in said second conduit to receive said fluid from said source and to said first valve assembly to supply fluid thereto, said vent valve having a vent to discharge said fluid, said vent valve being operable between a first position connecting said fluid source to said first valve assembly and a second position connecting said first valve assembly to said vent;
a controller connected to each of said plurality of flexible potentiometers for supplying an electrical signal thereto and for receiving said deflection signal there from, said controller also being connected to each of said plurality of solenoid valves and to said vent valve for supplying operating signals thereto, said controller being configured to generate operating signals for operating each of said solenoid valves of said first valve assembly between said first position and said second position and to said vent valve to cause it rotate between said first position and said second position.

2. The body support system of claim 1, further comprising a second valve assembly in fluid communication with said first valve assembly to transmit fluid under pressure there between, said second valve assembly comprising a plurality of solenoid valves each connected to be controllable by said controller and each connected to at least one of said plurality of inflatable chambers, each of the solenoid valves of said second valve assembly being operable between a first valve position to allow fluid flow to and from said at least one of said plurality of inflatable chambers and a second valve position inhibiting fluid flow to and from the said at least one of said plurality of inflatable chambers;

3. The inflatable body support system of claim 2, wherein the fluid source is an pump and said fluid is air.

4. The inflatable body support system of claim 3, wherein said first valve assembly has a first plenum connected to first vent valve and wherein said first valve assembly has a plurality of discharge ports for connection with said plurality of first conduits.

5. The inflatable body support system of claim 4, wherein said first valve assembly has six solenoid valves.

6. The inflatable body support system of claim 4, wherein said air pump supplies said fluid under pressure at a pressure of about up to 5 pounds per square inch.

7. The inflatable body support system of claim 4, wherein said air pump supplies said fluid under pressure at a pressure of about 0.5 pounds per square inch.

8. The inflatable body support system of claim 4, wherein said plurality of inflatable chambers are part of a mattress.

9. A support system for supporting at least a portion of a person's body, the support system comprising:
fluid supply means for providing a fluid under pressure;
a support for supporting a portion of the person's body, said support including a plurality of inflatable chambers each having a flexible wall member shaped to define an interior volume configured to receive and retain a fluid therein, each of said plurality of inflatable chambers having a chamber connector for communicating fluid into and out of said interior volume, said flexible wall member being deflectable when inflated with fluid between a first inflated position and a second inflated position, the second inflated position being different from said first inflated position;
detection means associated with each of said plurality of inflatable chambers for sensing the deflection of said flexible wall member between said first inflated position and said second inflated position;
a first valve assembly connected to receive fluid from said fluid source and to said chamber connector for communication of said fluid there between, said first valve assembly comprising a plurality of solenoid valves each configured to receive said fluid from said fluid source and each connected to at least one of said plurality of inflatable chambers to supply said fluid thereto, each of said solenoid valves of said first valve assembly being operable between a first valve position in which said fluid flows through said solenoid valve to and from said at least one of said plurality of inflatable chambers and a second valve position inhibiting fluid flow to and from the said at least one of said plurality of inflatable chambers;
first conduits connected to transmit the fluid to and from each of said solenoid valves to at least one inflatable chamber;
a second conduit connected to transmit fluid from said fluid supply means to said first valve assembly;
a vent valve positioned in said second conduit to receive said fluid from said fluid supply means and to said first valve assembly to transmit fluid there between, said vent valve having a vent to discharge said fluid, said vent valve being operable between a first position connecting said fluid source to said first valve assembly and a second position connecting said first valve assembly to said vent; and
a controller connected to said valve assembly and to said vent valve and to said fluid supply means for supplying operating signals thereto and to said detection means for receiving and supplying signals to and receiving signals from said detection means.

10. The support system of claim 9, further comprising a second valve assembly in fluidic communication with the first valve assembly to communicate fluid there between, the second valve assembly comprising a plurality of solenoid valves each connected to and controllable by said controller, and wherein said second valve assembly has first conduits attached for transmitting fluid between each of said solenoid valves of said second valve assembly and at least one inflatable chamber.

11. The support system of claim 10, wherein said fluid supply means is an air pump.

12. The support system of claim 11, wherein said detection means comprises a plurality of flexible potentiometers.

13. The support system of claim 5, wherein said support system comprises at least a portion of one of a bed, a seat, and a wheelchair.

14. In subcombination, a system for controlling a flow of a fluid to a plurality of inflatable chambers, the plurality of inflatable chambers each comprising a support surface for supporting at least a portion of a human body, the system comprising:
a plurality of flexible potentiometers, wherein at least one flexible potentiometer of the plurality of flexible potentiometers is attached to each of the plurality of inflatable chambers;
a plurality of pressure sensors, wherein at least one pressure sensor of the plurality of pressure sensors measures a fluid pressure within each of the plurality of inflatable chambers;
a plurality of solenoid valves for controlling the flow of fluid to the plurality of inflatable chambers; and
a controller for reading and analyzing data from the plurality of flexible potentiometers and the plurality of pressure sensors, and for instructing two or more solenoid valves of the plurality of solenoid valves to allow fluid to flow to or discharge from a corresponding two or more inflatable chambers during an overlapping period of time.
